(19) United States
(12) Patent Application Publication
(10) Pub. No.: US 2018/0032230 A1
(43) Pub. Date: Feb. 1, 2018

(54) INFORMATION PROCESSING METHOD AND SYSTEM FOR EXECUTING THE INFORMATION PROCESSING METHOD

(71) Applicant: COLOPL, Inc., Tokyo (JP)

(72) Inventors: Atsushi INOMATA, Tokyo (JP); Yasuhiro NOGUCHI, Tokyo (JP)

(21) Appl. No.: 15/661,137

(22) Filed: Jul. 27, 2017

(30) Foreign Application Priority Data
Jul. 28, 2016 (JP) 2016-148490
Jul. 28, 2016 (JP) 2016-148491
Aug. 8, 2016 (JP) 2016-156006
Jan. 18, 2017 (JP) 2017-006886

(51) Int. Cl. G06F 3/0481; H04N 13/04; G06F 3/01

(52) U.S. Cl. CPC G06F 3/04815; G06F 3/012; G06F 3/014; H04N 13/044; H04N 13/0468

(57) ABSTRACT

An information processing method includes generating virtual space data for defining a virtual space that includes a virtual camera, an operation object, and a target object. The method further includes generating visual-field image data based on a visual field of the virtual camera and the virtual space data. The method further includes displaying a visual-field image on a head-mounted display (HMD). The method further includes moving the operation object in accordance with a detected movement of a part of a body of a user. The method further includes identifying a relative relationship between the HMD and the part of the body of the user. The method further includes setting a collision effect. The collision effect defines an effect exerted by the operation object on the target object. The collision effect is set based on the identified relative relationship.

### RELATED APPLICATIONS

The present application claims priority to JP2016-148490 filed Jul. 28, 2016, JP 2016-148491 filed Jul. 28, 2016, JP 2017-006886 filed Jan. 18, 2017 and JP 2016-156006 filed Aug. 8, 2016 the disclosures of which are hereby incorporated by reference herein in its entirety.

### TECHNICAL FIELD

This disclosure relates to an information processing method and a system for executing the information processing method.

### BACKGROUND

In Non-Patent Document 1, there is described a technology of changing a state of a hand object in a virtual reality (VR) space based on a state (for example, position and inclination) of a hand of a user in a real space, and operating the hand object to exert a predetermined action on a predetermined object in the virtual space.

### Non-Patent Documents

[Non-Patent Document 1] “Toybox Demo for Oculus Touch”, [online], Oct. 13, 2015, Oculus, [retrieved on Aug. 6, 2016], Internet <https://www.youtube.com/watch?v=iFEMiyGMa58>

### SUMMARY

In Non-Patent Document 1, there is room for improving a virtual experience in a virtual reality space.

At least one embodiment of this disclosure has an object to provide an information processing method and a system for executing the information processing method, which are capable of improving a virtual experience.

According to at least one aspect of this disclosure, there is provided an information processing method to be executed by a computer in a system including a head-mounted device and a position sensor configured to detect a position of the head-mounted device and a position of a part of a body other than a head of a user. The information processing method includes generating virtual space data for defining a virtual space that includes an operation object and a target object. The method further includes displaying a visual-field image on the head-mounted device based on the position and an inclination of the head-mounted device. The method further includes identifying a position of the operation object based on the position of the part of the body of the user. The method further includes avoiding causing the operation object to exert a predetermined effect on the target object in response to a determination that a predetermined condition for determining whether or not a collision area of the operation object has touched a collision area of the target object intentionally is not satisfied.

According to at least one embodiment of this disclosure, improving the virtual experience in the virtual reality space is possible.

### BRIEF DESCRIPTION OF THE DRAWINGS

FIG. 1 A schematic diagram of a head-mounted device (HMD) system according to at least one embodiment.

FIG. 2 A diagram of a head of a user wearing an HMD according to at least one embodiment.

FIG. 3 A diagram of a hardware configuration of a control device according to at least one embodiment.

FIG. 4 A diagram of an example of a configuration of an external controller according to at least one embodiment.

FIG. 5 A flowchart of a method of displaying a visual-field image on the HMD according to at least one embodiment.

FIG. 6 An xyz spatial diagram of an example of a virtual space according to at least one embodiment.

FIG. 7A A yx plane diagram of the virtual space in FIG. 6 according to at least one embodiment.

FIG. 7B A zx plane diagram of the virtual space in FIG. 6 according to at least one embodiment.

FIG. 8 A diagram of an example of the visual-field image displayed on the HMD according to at least one embodiment.

FIG. 9A A diagram of a user wearing the HMD and the external controller according to at least one embodiment.

FIG. 9B A diagram of the virtual space including a virtual camera, a hand object, and a wall object according to at least one embodiment.

FIG. 10 A flowchart of an information processing method according to at least one embodiment of this disclosure.

FIG. 11A A diagram of a state in which a user moves a left-hand external controller greatly forward according to at least one embodiment.

FIG. 11B A diagram of the wall object destroyed by the left hand object under the state in FIG. 11A according to at least one embodiment.

FIG. 12A A diagram of a state in which the user moves the left-hand external controller a little forward according to at least one embodiment.

FIG. 12B A diagram of the wall object destroyed by the left hand object under the state in FIG. 12A according to at least one embodiment.

FIG. 13A A diagram of a pattern of a collision area of the left hand object and a range of an effect exerted on the wall object according to at least one embodiment.

FIG. 13B A diagram of a pattern of a collision area of the left hand object and the range of an effect exerted on the wall object according to at least one embodiment.

FIG. 14 A flowchart of an information processing method according to at least one embodiment.

FIG. 15A A diagram of the user wearing the HMD and the external controller according to at least one embodiment.

FIG. 15B A diagram of the virtual space including the virtual camera, the hand object, and the wall object according to at least one embodiment.

FIG. 16A A diagram of the user wearing the HMD and the external controller according to at least one embodiment.

FIG. 16B A diagram of the virtual space including the virtual camera, the hand object, and the wall object according to at least one embodiment.

FIG. 17A A diagram of the virtual camera before movement, the hand object, and the wall object according to at least one embodiment.

FIG. 17B A diagram of the virtual space including the virtual camera after movement, the hand object, and the wall object according to at least one embodiment.

FIG. 18 A flowchart of an information processing method according to at least one embodiment.

FIG. 19A A diagram of how the user moves forward (+w direction) at a speed faster than a predetermined speed according to at least one embodiment.

FIG. 19B A diagram of the wall object destroyed by the left hand object under the state of FIG. 19A according to at least one embodiment.

FIG. 20A A diagram of how the user moves forward at a speed slower than the predetermined speed according to at least one embodiment.

FIG. 20B A diagram for illustrating the wall object destroyed by the left hand object under the state in FIG. 20A according to at least one embodiment.

FIG. 21 A flowchart an information processing method according to at least one embodiment.

FIG. 22A A diagram of a pattern of the collision area of the left hand object and the range of an effect exerted on the wall object according to at least one embodiment.

FIG. 22B A diagram a diagram of a pattern of the collision area of the left hand object and the range of an effect exerted on the wall object according to at least one embodiment.

FIG. 23A A diagram of a real space including the user wearing the HMD and the external controller according to at least one embodiment.

FIG. 23B A diagram of the virtual space including the virtual camera, a right hand object, the left hand object, a block object, and a button object according to at least one embodiment.

FIG. 24 A plan-view diagram of the virtual space of how the collision area of the right hand object touches an operation portion of the button object according to at least one embodiment.

FIG. 25 A flowchart of an information processing method according to at least one embodiment.

FIG. 26 A flowchart of an information processing method according to at least one embodiment.

FIG. 27 A flowchart of an information processing method according to at least one embodiment.

FIG. 28 A plan-view diagram of the virtual space of a state in which the right hand object and the button object are outside the visual field of the virtual camera according to at least one embodiment.

FIG. 29 A flowchart of an information processing method according to at least one embodiment.

FIG. 30 A flowchart of an information processing method according to at least one embodiment of this disclosure.

### DETAILED DESCRIPTION

Embodiments of this disclosure are described below with reference to the drawings. Once a component is described in this description of the embodiments, a description on a component having the same reference number as that of the already described component is omitted for the sake of convenience.

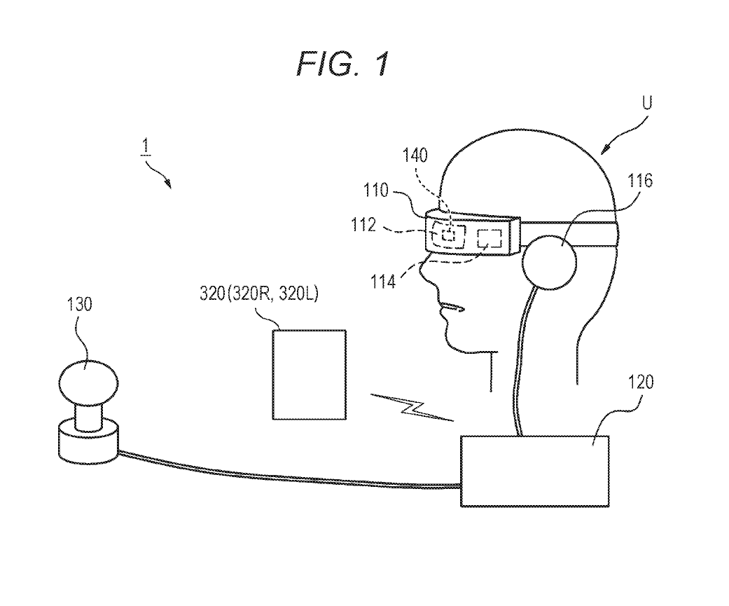

First, with reference to FIG. 1, a configuration of a head-mounted device (HMD) system 1 is described. FIG. 1 is a schematic view of the HMD system 1 according to at least one embodiment. In FIG. 1, the HMD system 1 includes an HMD 110 worn on a head of a user U, a position sensor 130, a control device 120, and an external controller 320.

The HMD 110 includes a display unit 112, an HMD sensor 114, and an eye gaze sensor 140. The display unit 112 includes a non-transmissive display device configured to cover a field of view (visual field) of the user U wearing the HMD 110. With this, the user U can see a visual-field image displayed on the display unit 112, and thus the user U can be immersed in a virtual space. The HMD 110 is, for example, a head-mounted display device having the display unit 112 constructed integrally or separately. The display unit 112 may include a left-eye display unit configured to provide an image to a left eye of the user U, and a right-eye display unit configured to provide an image to a right eye of the user U. Further, the HMD 110 may include a transmissive display device. In this case, the transmissive display device may be able to be temporarily configured as the non-transmissive display device by adjusting the transmittance thereof. Further, the visual-field image may include a configuration for presenting a real space in a part of the image forming the virtual space. For example, an image taken by a camera mounted to the HMD 110 may be displayed so as to be superimposed on a part of the visual-field image, or a transmittance of a part of the transmissive display device may be set high to enable the user to visually recognize the real space through a part of the visual-field image.

The HMD sensor 114 is mounted near the display unit 112 of the HMD 110. The HMD sensor 114 includes at least one of a geomagnetic sensor, an acceleration sensor, or an inclination sensor (for example, an angular velocity sensor or a gyro sensor), and can detect various movements of the HMD 110 worn on the head of the user U.

The eye gaze sensor 140 has an eye tracking function of detecting a line-of-sight direction of the user U. For example, the eye gaze sensor 140 may include a right-eye gaze sensor and a left-eye gaze sensor. The right-eye gaze sensor may be configured to detect reflective light reflected from the right eye (in particular, the cornea or the iris) of the user U by irradiating the right eye with, for example, infrared light, to thereby acquire information relating to a rotational angle of a right eyeball. Meanwhile, the left-eye gaze sensor may be configured to detect reflective light reflected from the left eye (in particular, the cornea or the iris) of the user U by irradiating the left eye with, for example, infrared light, to thereby acquire information relating to a rotational angle of a left eyeball.

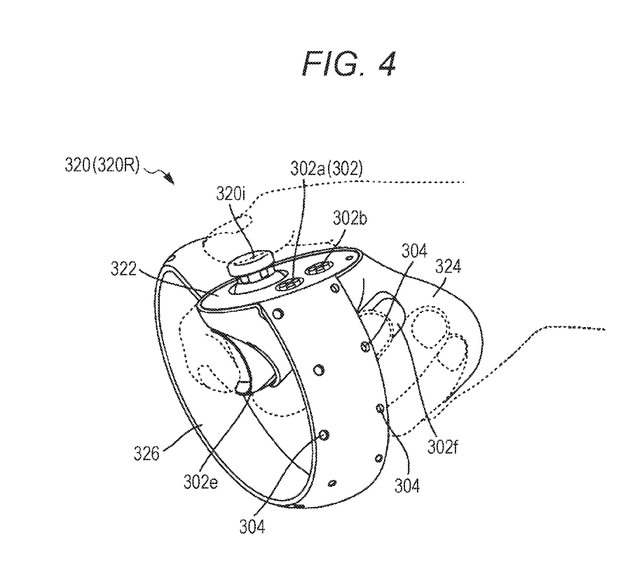

The position sensor 130 is constructed of, for example, a position tracking camera, and is configured to detect the positions of the HMD 110 and the external controller 320. The position sensor 130 is connected to the control device 120 so as to enable communication to/from the control device 120 in a wireless or wired manner. The position sensor 130 is configured to detect information relating to positions, inclinations, or light emitting intensities of a plurality of detection points (not shown) provided in the HMD 110. Further, the position sensor 130 is configured to detect information relating to positions, inclinations, and/or light emitting intensities of a plurality of detection points 304 (refer to FIG. 4) provided in the external controller 320. The detection points are, for example, light emitting portions configured to emit infrared light or visible light. Further, the position sensor 130 may include an infrared sensor or a plurality of optical cameras.

The control device 120 is capable of acquiring movement information such as the position and the direction of the HMD 110 based on the information acquired from the HMD sensor 114 or the position sensor 130, and accurately associating a position and a direction of a virtual point of view (virtual camera) in the virtual space with the position and the direction of the user U wearing the HMD 110 in the real space based on the acquired movement information. Further, the control device 120 is capable of acquiring movement information of the external controller 320 based on the information acquired from the position sensor 130, and accurately associating a position and a direction of a hand object (described later) to be displayed in the virtual space with a relative relationship of the position and the direction between the external controller 320 and the HMD 110 in the real space based on the acquired movement information. Similarly to the HMD sensor 114, the movement information of the external controller 320 may be obtained from a geomagnetic sensor, an acceleration sensor, an inclination sensor, or other sensors mounted to the external controller 320.

The control device 120 is capable of identifying each of the line of sight of the right eye and the line of sight of the left eye of the user U based on the information transmitted from the eye gaze sensor 140, to thereby identify a point of gaze being an intersection between the line of sight of the right eye and the line of sight of the left eye. Further, the control device 120 is capable of identifying a line-of-sight direction of the user U based on the identified point of gaze. In this case, the line-of-sight direction of the user U is a line-of-sight direction of both eyes of the user U, and matches with a direction of a straight line passing through the point of gaze and a midpoint of a line segment connecting between the right eye and the left eye of the user U.

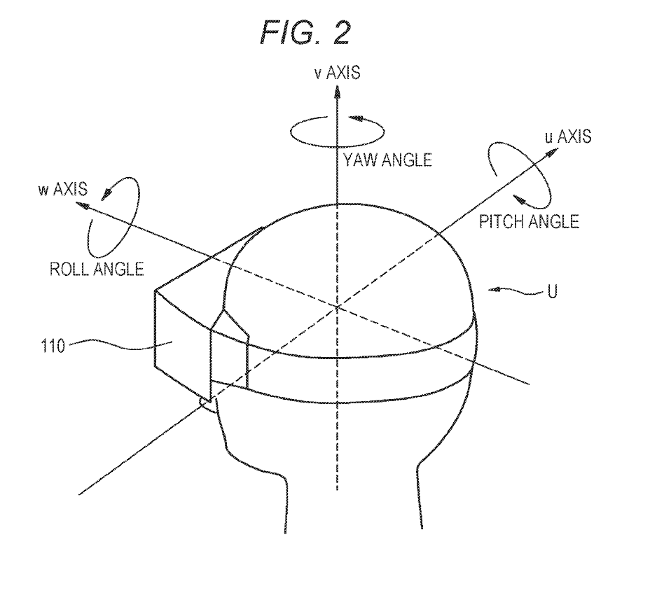

With reference to FIG. 2, a method of acquiring information relating to a position and a direction of the HMD 110 is described. FIG. 2 is a diagram of the head of the user U wearing the HMD 110 according to at least one embodiment. The information relating to the position and the direction of the HMD 110, which are synchronized with the movement of the head of the user U wearing the HMD 110, can be detected by the position sensor 130 and/or the HMD sensor 114 mounted on the HMD 110. In FIG. 2, three-dimensional coordinates (uvw coordinates) are defined about the head of the user U wearing the HMD 110. A perpendicular direction in which the user U stands upright is defined as a v axis, a direction being orthogonal to the v axis and passing through the center of the HMD 110 is defined as a w axis, and a direction orthogonal to the v axis and the w axis is defined as a u direction. The position sensor 130 and/or the HMD sensor 114 are/is configured to detect angles about the respective uvw axes (that is, inclinations determined by a yaw angle representing the rotation about the v axis, a pitch angle representing the rotation about the u axis, and a roll angle representing the rotation about the w axis). The control device 120 is configured to determine angular information for defining a visual axis from the virtual viewpoint based on the detected change in angles about the respective uvw axes.

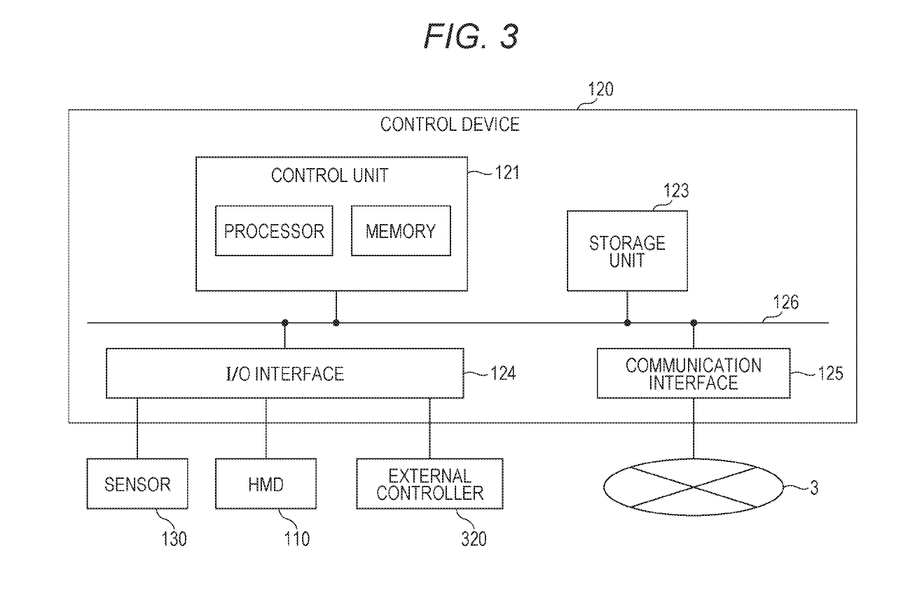

With reference to FIG. 3, a hardware configuration of the control device 120 is described. FIG. 3 is a diagram of the hardware configuration of the control device 120 according to at least one embodiment. The control device 120 includes a control unit 121, a storage unit 123, an input/output (I/O) interface 124, a communication interface 125, and a bus 126. The control unit 121, the storage unit 123, the I/O interface 124, and the communication interface 125 are connected to each other via the bus 126 so as to enable communication therebetween.

The control device 120 may be constructed as a personal computer, a tablet computer, or a wearable device separately from the HMD 110, or may be built into the HMD 110. Further, a part of the functions of the control device 120 may be mounted to the HMD 110, and other functions of the control device 120 may be mounted to another device separate from the HMD 110.

The control unit 121 includes a memory and a processor. The memory is constructed of, for example, a read only memory (ROM) having various programs and the like stored therein or a random access memory (RAM) having a plurality of work areas in which various programs to be executed by the processor are stored. The processor is constructed of, for example, a central processing unit (CPU), a micro processing unit (MPU) and/or a graphics processing unit (GPU), and is configured to develop, on the RAM, programs designated by various programs installed into the ROM to execute various types of processing in cooperation with the RAM.

The control unit 121 may control various operations of the control device 120 by causing the processor to develop, on the RAM, a program (to be described later) for executing the information processing method on a computer according to at least one embodiment to execute the program in cooperation with the RAM. The control unit 121 executes a predetermined application program (including a game program and an interface program) stored in the memory or the storage unit 123 to display a virtual space (visual-field image) on the display unit 112 of the HMD 110. With this, the user U can be immersed in the virtual space displayed on the display unit 112.

The storage unit (storage) 123 is a storage device, for example, a hard disk drive (HDD), a solid state drive (SSD), or a USB flash memory, and is configured to store programs and various types of data. The storage unit 123 may store the program for executing the information processing method on a computer according to at least one embodiment. Further, the storage unit 123 may store programs for authentication of the user U and game programs including data relating to various images and objects. Further, a database including tables for managing various types of data may be constructed in the storage unit 123.

The I/O interface 124 is configured to connect each of the position sensor 130, the HMD 110, and the external controller 320 to the control device 120 so as to enable communication therebetween, and is constructed of, for example, a universal serial bus (USB) terminal, a digital visual interface (DVI) terminal, or a High-Definition Multimedia Interface® (HDMI) terminal. The control device 120 may be wirelessly connected to each of the position sensor 130, the HMD 110, and the external controller 320.

The communication interface 125 is configured to connect the control device 120 to a communication network 3, for example, a local area network (LAN), a wide area network (WAN), or the Internet. The communication interface 125 includes various wire connection terminals and various processing circuits for wireless connection for communication to/from an external device on a network via the communication network 3, and is configured to adapt to communication standards for communication via the communication network 3.

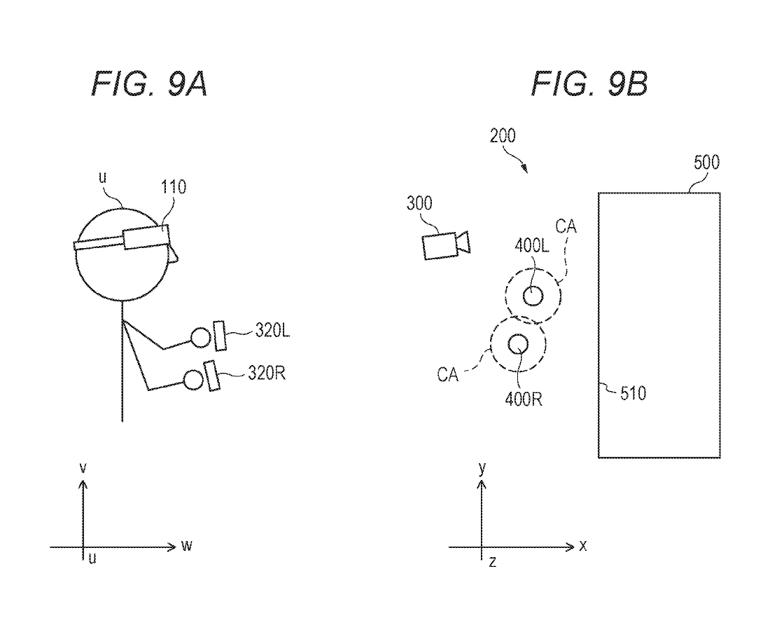

With reference to FIG. 4, an example of a specific configuration of the external controller 320 is described. The external controller 320 is used to control a movement of a hand object to be displayed in the virtual space by detecting a movement of a part of a body of the user U other than the head. For example, hand of the user U in at least one embodiment. The external controller 320 includes a right-hand external controller 320R (hereinafter simply referred to as “controller 320R”) to be operated by the right hand of the user U, and a left-hand external controller 320L (hereinafter simply referred to as “controller 320L”) to be operated by the left hand of the user U. The controller 320R is a device for representing the position of the right hand and the movement of the fingers of the right hand of the user U. Further, a right hand object 400R (refer to FIG. 9) present in the virtual space moves based on the movement of the controller 320R. The controller 320L is a device for representing the position of the left hand and the movement of the fingers of the left hand of the user U. Further, a left hand object 400L (refer to FIG. 9) present in the virtual space moves based on the movement of the controller 320L. The controller 320R and the controller 320L substantially have similar configurations, and thus description is given only of the specific configuration of the controller 320R in the following with reference to FIG. 4. In the following description, for the sake of convenience, the controllers 320L and 320R are sometimes simply and collectively referred to as “external controller 320”.

In FIG. 4, the controller 320R includes an operation button 302, a plurality of detection points 304, a sensor (not shown), and a transceiver (not shown). Only one of the sensor and the detection points 304 needs to be provided according to at least one embodiment. The operation button 302 includes a plurality of button groups configured to receive operation input from the user U. The operation button 302 includes a push button, a trigger button, and an analog stick. The push button is a button to be operated through a depression motion by the thumb. For example, two push buttons 302a and 302b are provided on a top surface 322. The trigger button is a button to be operated through such a motion that the index finger or the middle finger pulls a trigger. For example, a trigger button 302e is provided in a front surface part of a grip 324, and a trigger button 302f is provided in a side surface part of the grip 324. The trigger buttons 302e and 302f are intended to be operated by the index finger and the middle finger, respectively. The analog stick is a stick button that may be operated by being tilted in an arbitrary direction of 360 degrees from a predetermined neutral position. For example, an analog stick 320i is provided on the top surface 322, and is intended to be operated with use of the thumb.

The controller 320R includes a frame 326 that extends from both side surfaces of the grip 324 in directions opposite to the top surface 322 to form a semicircular ring. The plurality of detection points 304 are embedded in the outer side surface of the frame 326. The plurality of detection points 304 are, for example, a plurality of infrared LEDs arranged in one row along a circumferential direction of the frame 326. The position sensor 130 detects information relating to positions, inclinations, and light emitting intensities of the plurality of detection points 304, and then the control device 120 acquires the movement information including the information relating to the position and the attitude (inclination and direction) of the controller 320R based on the information detected by the position sensor 130.

The sensor of the controller 320R may be, for example, any one of a magnetic sensor, an angular velocity sensor, an acceleration sensor, or a combination of those sensors. The sensor outputs a signal (for example, a signal indicating information relating to magnetism, angular velocity, or acceleration) based on the direction and the movement of the controller 320R when the user U moves the controller 320R. The control device 120 acquires information relating to the position and the attitude of the controller 320R based on the signal output from the sensor.

The transceiver of the controller 320R is configured to perform transmission or reception of data between the controller 320R and the control device 120. For example, the transceiver may transmit an operation signal corresponding to the operation input of the user U to the control device 120. Further, the transceiver may receive from the control device 120 an instruction signal for instructing the controller 320R to cause light emission of the detection points 304. Further, the transceiver may transmit a signal representing the value detected by the sensor to the control device 120.

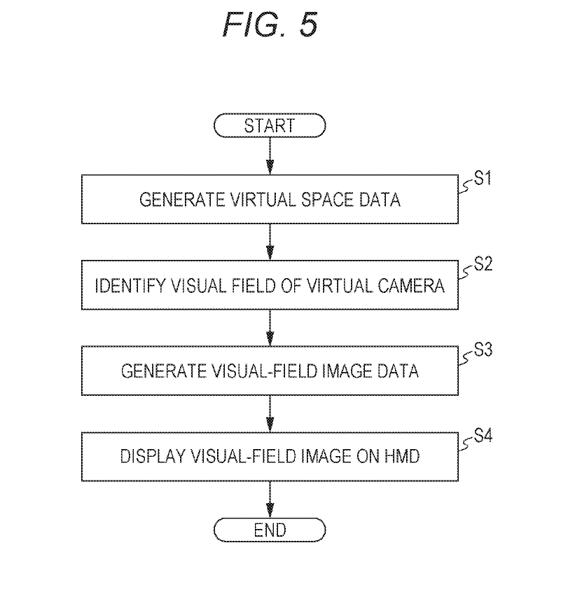

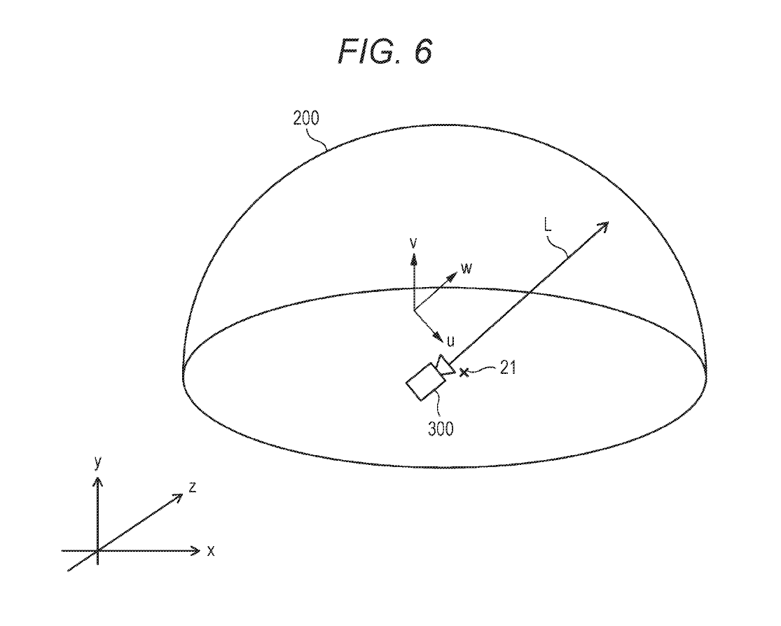

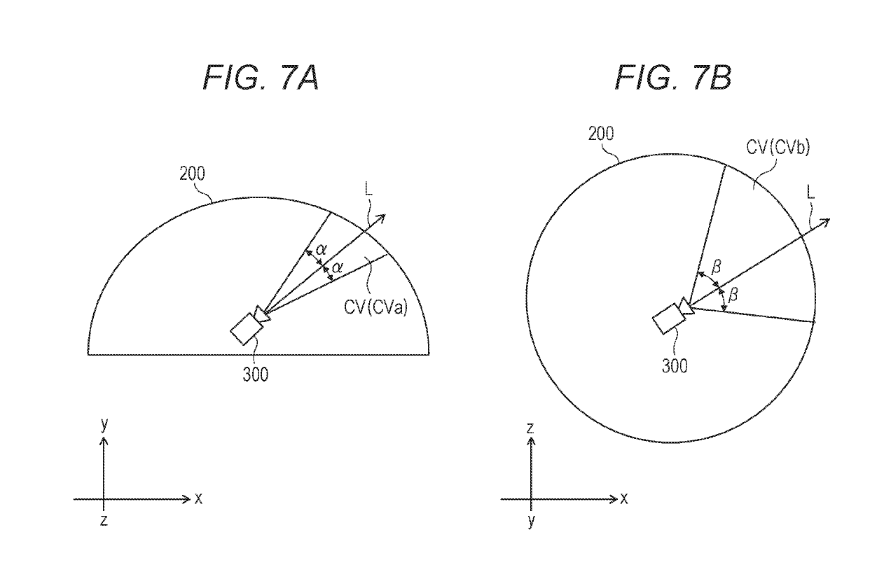

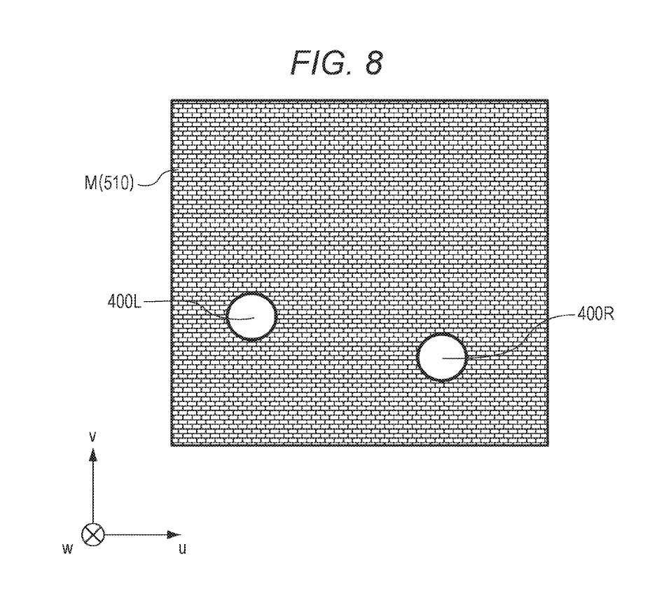

With reference to FIG. 5 to FIG. 8, processing for displaying the visual-field image on the HMD 110 is described. FIG. 5 is a flowchart of processing of displaying the visual-field image on the HMD 110 according to at least one embodiment. FIG. 6 is an xyz spatial diagram of a virtual space 200 according to at least one embodiment. FIG. 7A is a yx plane diagram of the virtual space 200 in FIG. 6 according to at least one embodiment. FIG. 7B is a zx plane diagram of the virtual space 200 in FIG. 6 according to at least one embodiment. FIG. 8 is a diagram of an example of a visual-field image M displayed on the HMD 110 according to at least one embodiment.

In FIG. 5, in Step S1, the control unit 121 (refer to FIG. 3) generates virtual space data representing the virtual space 200 including a virtual camera 300 and various objects. In FIG. 6, the virtual space 200 is defined as an entire celestial sphere having a center position 21 as the center (in FIG. 6, only the upper-half celestial sphere is illustrated). Further, in the virtual space 200, an xyz coordinate system having the center position 21 as the origin is set. The virtual camera 300 defines a visual axis L for identifying the visual-field image M (refer to FIG. 8) to be displayed on the HMD 110. The uvw coordinate system that defines the visual field of the virtual camera 300 is determined so as to synchronize with the uvw coordinate system that is defined about the head of the user U in the real space. Further, the control unit 121 may move the virtual camera 300 in the virtual space 200 in synchronization with the movement in the real space of the user U wearing the HMD 110. Further, the various objects in the virtual space 200 include, for example, the left hand object 400L, the right hand object 400R, and a wall object 500 (refer to FIG. 9).

In Step S2, the control unit 121 identifies a visual field CV (refer to FIG. 7) of the virtual camera 300. Specifically, the control unit 121 acquires information relating to a position and an inclination of the HMD 110 based on data representing the state of the HMD 110, which is transmitted from the position sensor 130 and/or the HMD sensor 114. Next, the control unit 121 identifies the position and the direction of the virtual camera 300 in the virtual space 200 based on the information relating to the position and the inclination of the HMD 110. Next, the control unit 121 determines the visual axis L of the virtual camera 300 based on the position and the direction of the virtual camera 300, and identifies the visual field CV of the virtual camera 300 based on the determined visual axis L. In this case, the visual field CV of the virtual camera 300 corresponds to a part of the region of the virtual space 200 that can be visually recognized by the user U wearing the HMD 110. In other words, the visual field CV corresponds to a part of the region of the virtual space 200 to be displayed on the HMD 110. Further, the visual field CV has a first region CVa set as an angular range of a polar angle α about the visual axis L in the xy plane in FIG. 7A, and a second region CVb set as an angular range of an azimuth β about the visual axis L in the xz plane in FIG. 7B. The control unit 121 may identify the line-of-sight direction of the user U based on data representing the line-of-sight direction of the user U, which is transmitted from the eye gaze sensor 140, and may determine the direction of the virtual camera 300 based on the line-of-sight direction of the user U.

The control unit 121 can identify the visual field CV of the virtual camera 300 based on the data transmitted from the position sensor 130 and/or the HMD sensor 114. In this case, when the user U wearing the HMD 110 moves, the control unit 121 can change the visual field CV of the virtual camera 300 based on the data representing the movement of the HMD 110, which is transmitted from the position sensor 130 and/or the HMD sensor 114. That is, the control unit 121 can change the visual field CV in accordance with the movement of the HMD 110. Similarly, when the line-of-sight direction of the user U changes, the control unit 121 can move the visual field CV of the virtual camera 300 based on the data representing the line-of-sight direction of the user U, which is transmitted from the eye gaze sensor 140. That is, the control unit 121 can change the visual field CV in accordance with the change in the line-of-sight direction of the user U.

In Step S3, the control unit 121 generates visual-field image data representing the visual-field image M to be displayed on the display unit 112 of the HMD 110. Specifically, the control unit 121 generates the visual-field image data based on the virtual space data defining the virtual space 200 and the visual field CV of the virtual camera 300.

In Step S4, the control unit 121 displays the visual-field image M on the display unit 112 of the HMD 110 based on the visual-field image data (refer to FIGS. 7A and 7B). As described above, the visual field CV of the virtual camera 300 is updated in accordance with the movement of the user U wearing the HMD 110, and thus the visual-field image M to be displayed on the display unit 112 of the HMD 110 is updated as well. Thus, the user U can be immersed in the virtual space 200.

The virtual camera 300 may include a left-eye virtual camera and a right-eye virtual camera. In this case, the control unit 121 generates left-eye visual-field image data representing a left-eye visual-field image based on the virtual space data and the visual field of the left-eye virtual camera. Further, the control unit 121 generates right-eye visual-field image data representing a right-eye visual-field image based on the virtual space data and the visual field of the right-eye virtual camera. After that, the control unit 121 displays the left-eye visual-field image and the right-eye visual-field image on the display unit 112 of the HMD 110 based on the left-eye visual-field image data and the right-eye visual-field image data. In this manner, the user U can visually recognize the visual-field image as a three-dimensional image from the left-eye visual-field image and the right-eye visual-field image. In this disclosure, for the sake of convenience in description, the number of the virtual cameras 300 is one. However, at least one embodiment of this disclosure is also applicable to a case in which the number of the virtual cameras is two.

Now, a description is given of the left hand object 400L, the right hand object 400R, and the wall object 500 included in the virtual space 200 with reference to FIG. 9. FIG. 9A is a diagram of the user U wearing the HMD 110 and the controllers 320L and 320R according to at least one embodiment. FIG. 9B is a diagram of the virtual space 200 including the virtual camera 300, the left hand object 400L (example of operation object), the right hand object 400R (example of operation object), and the wall object 500 (example of target object) according to at least one embodiment.

In FIG. 9B, the virtual space 200 includes the virtual camera 300, the left hand object 400L, the right hand object 400R, and the wall object 500. The control unit 121 generates the virtual space data for defining the virtual space 200 including those objects. As described above, the virtual camera 300 is synchronized with the movement of the HMD 110 worn by the user U. That is, the visual field of the virtual camera 300 is updated based on the movement of the HMD 110. The left hand object 400L is an operation object configured to move in accordance with movement of the controller 320L worn on the left hand of the user U. Similarly, the right hand object 400R is an operation object configured to move in accordance with movement of the controller 320R worn on the right hand of the user U. In the following, the left hand object 400L and the right hand object 400R may simply be referred to as “hand object 400” for the sake of convenience of description. Further, each of the left hand object 400L and the right hand object 400R has a collision area CA. The collision area CA is used for determination of a collision (determination of hit) between the hand object 400 and the target object (for example, the wall object 500). For example, the collision area CA of the hand object 400 and a collision area of the target object have touched each other so that a predetermined effect is exerted on the target object, for example, the wall object 500. In FIG. 9B, the collision area CA may be defined by, for example, a sphere having a center position of the hand object 400 as a center and a diameter R. In the following description, the collision area CA is formed to have a sphere shape having a center position of the hand object 400 and as a center the diameter R. In at least one embodiment, collision area CA has a different shape and or a different positional relationship with respect to the hand object 400.

The wall object 500 is a target object that the left hand object 400L and the right hand object 400R exert an effect on. For example, when the left hand object 400L has touched the wall object 500, a part of the wall object 500, which touches the collision area CA of the left hand object 400L, is destroyed. Further, the wall object 500 also has a collision area, and in at least one embodiment, the collision area of the wall object 500 is the same as the area constructing the wall object 500. In at least one embodiment, the collision area of the wall object 500 is different from the area constructing the wall object 500.

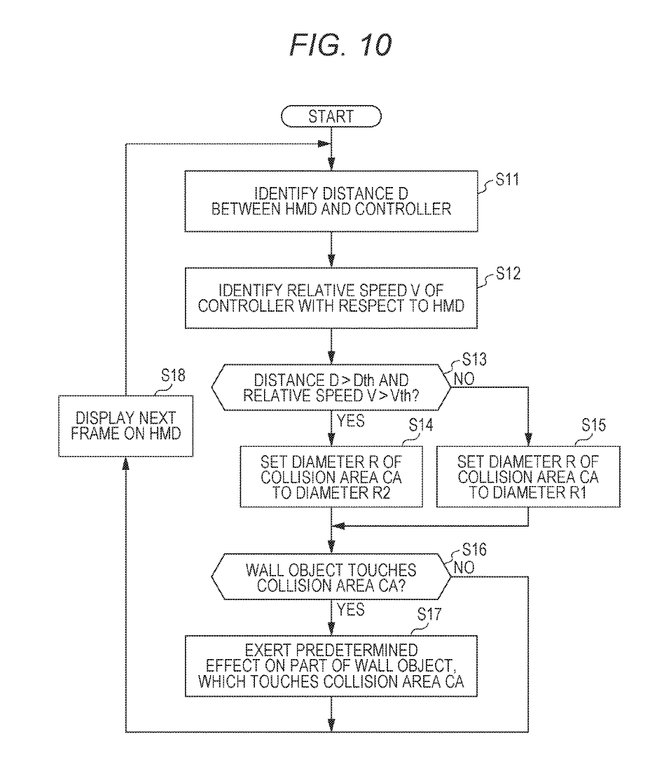

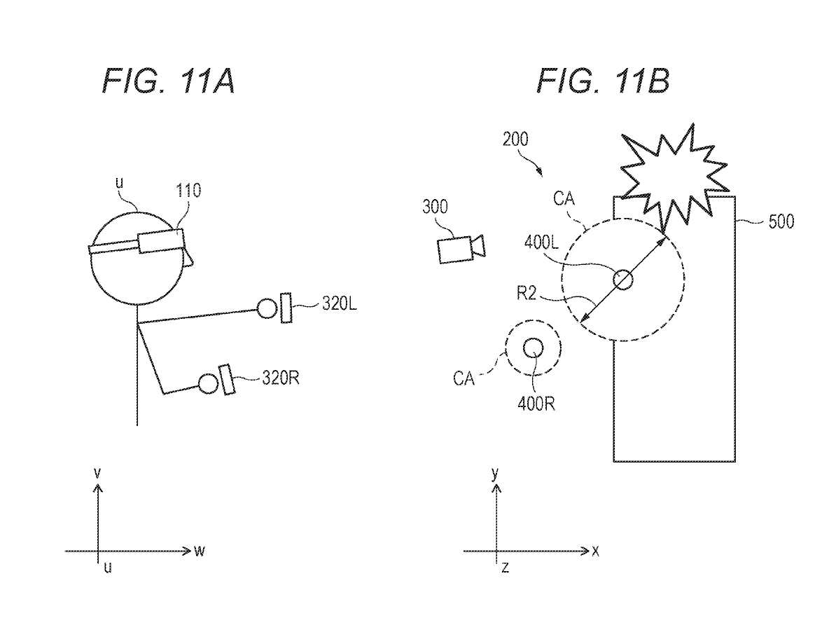

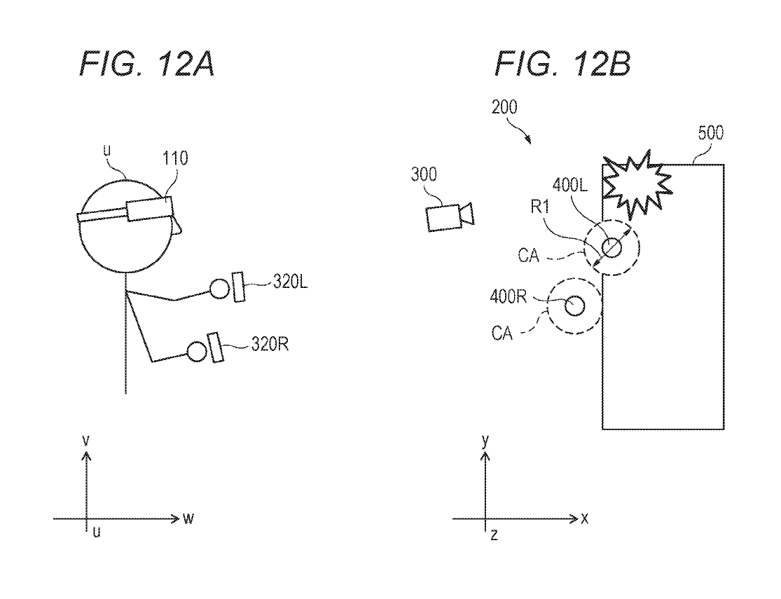

Now, a description is given of an information processing method according to at least one embodiment of this disclosure with reference to FIG. 10 to FIG. 12. FIG. 10 is a flowchart of an information processing method according to at least one embodiment. FIG. 11A is a diagram of a state in which the user U moves the controller 320L greatly forward (+w direction) according to at least one embodiment. FIG. 11B is a diagram of the wall object 500 destroyed by the left hand object 400L under the state of FIG. 11A according to at least one embodiment. FIG. 12A is a diagram of a state in which the user U moves the controller 320L a little forward (+w direction) according to at least one embodiment. FIG. 12B is a diagram of the wall object 500 destroyed by the left hand object 400L under the state of FIG. 12B according to at least one embodiment.

In the information processing method according to at least one embodiment, the control unit 121 is configured to set a collision effect for defining an effect exerted by the collision area associated with left hand object 400L n the wall object 500, and to seta collision effect for defining an effect exerted by the a collision area associated with right hand object 400R the wall object 500. Meanwhile, the controllers 320L and 320R have substantially the same configuration, and thus, in the following, a description is given only of a collision effect for defining an effect exerted by the controller 320L on the wall object 500 for the sake of convenience of description. In at least one embodiment, a collision effect associated with left hand object 400L is different from a collision effect associated with right hand object 400R. Further, the control unit 121 executes processing steps in FIG. 10 on a frame (still image forming moving image) basis in at least one embodiment. Instead, in at least one embodiment, the control unit 121 may execute the processing steps in FIG. 10 at predetermined time intervals.

In FIG. 10, in Step S11, the control unit 121 identifies a distance D (example of relative relationship) between the HMD 110 and the controller 320L. Specifically, the control unit 121 acquires position information on the HMD 110 and position information on the controller 320L based on information acquired from the position sensor 130, and identifies the distance D between the HMD 110 and the controller 320L in the w-axis direction of the HMD 110 based on those acquired pieces of position information. In at least one embodiment, the control unit 121 identifies the distance D between the HMD 110 and the controller 320L in the w-axis direction, but may identify the distance between the HMD 110 and the controller 320L in a predetermined direction other than the w-axis direction. Further, the control unit 121 may identify a straight distance between the HMD 110 and the controller 320L. In this case, when the position vector of the HMD 110 is set to PH and the position vector of the controller 320L is set to PL, the straight distance between the HMD 110 and the controller 320L is |PH−PL|.

Next, in Step S12, the control unit 121 identifies a relative speed V of the controller 320L with respect to the HMD 110. Specifically, the control unit 121 acquires position information on the HMD 110 and position information on the controller 320L based on information acquired from the position sensor 130, and identifies the relative speed V (example of relative relationship) of the controller 320L with respect to the HMD 110 in the w-axis direction of the HMD 110 based on those acquired pieces of position information.

For example, when the distance between the HMD 110 and the controller 320L in the w-axis direction for an n-th frame (n is an integer of 1 or more) is set to Dn, the distance between the HMD 110 and the controller 320L in the w-axis direction for an (n+1)-th frame is set to Dn+1, and a time interval between frames is set to ΔT, a relative speed Vn in the w-axis direction for the n-th frame is Vn=(Dn−Dn+1)/ΔT. When the frame rate of the moving image is 90 fps, ΔT is 1/90.

Next, in Step S13, the control unit 121 determines whether or not the identified distance D is larger than a predetermined distance Dth, and determines whether or not the identified relative speed V is larger than a predetermined relative speed Vth. The predetermined distance Dth and the predetermined relative speed Vth may appropriately be set depending on details of a game. When the control unit 121 determines that the identified distance D is larger than the predetermined distance Dth (D>Dth) and the identified relative speed V is larger than the predetermined relative speed Vth (V>Vth) (YES in Step S13), as in FIG. 11B, the control unit 121 sets a diameter R of the collision area CA of the left hand object 400L to a diameter R2 (Step S14). On the contrary, when the control unit 121 determines that D>Dth or V>Vth is not satisfied (NO in Step S13), as in FIG. 12B, the control unit 121 sets the diameter R of the collision area CA of the left hand object 400L to a diameter R1 (R1<R2) (Step S15). In this manner, the size of the collision area CA is set depending on the distance D between the HMD 110 and the controller 320L and the relative speed V of the controller 320L with respect to the HMD 110. In Step S14 and Step S15, the radius of the collision area CA may be set depending on the distance D and the relative speed V instead of the diameter of the collision area CA. In at least one embodiment predetermined distance D is set based on a distance traveled in real time, e.g., within a refresh rate of the HMD such as 90 frames per second (fps).

Next, in Step S16, the control unit 121 determines whether or not the wall object 500 touches the collision area CA of the left hand object 400L. When the control unit 121 determines that the wall object 500 touches the collision area CA of the left hand object 400L (YES in Step S16), a predetermined effect is exerted on a part of the wall object 500, which touches the collision area CA (Step S17). For example, the part of the wall object 500, which touches the collision area CA, may be destroyed, or the wall object 500 may be damaged by a predetermined amount. In FIG. 11B, the part of the wall object 500, which touches the collision area CA of the left hand object 400L, is destroyed. Further, because the collision area CA of the left hand object 400L in FIG. 11B is larger than the collision area CA of the left hand object 400L in FIG. 12B (because R2>R1), the wall object 500 is destroyed by the left hand object 400L by a larger amount in the state in FIG. 11B than in the state in FIG. 12B.

On the contrary, when the control unit 121 determines that the wall object 500 does not touch the collision area CA of the left hand object 400L (NO in Step S16), a predetermined effect is not exerted on the wall object 500. After that, the control unit 121 updates virtual space data for defining the virtual space including the wall object 500, and displays a next frame (still image) on the HMD 110 based on the updated virtual space data (Step S18). After that, the processing returns to Step S11.

In this manner, according to at least one embodiment, the effect (collision effect) of the controller 320L exerted on the wall object 500 is set depending on the relative relationship (relative positional relationship and relative speed) between the HMD 110 and the controller 320L, and thus improving the sense of immersion of the user U in the virtual space 200 is possible. In particular, the size (diameter) of the collision area CA of the left hand object 400L is set depending on the distance D between the HMD 110 and the controller 320L and the relative speed V of the controller 320L with respect to the HMD 110. Further, a predetermined effect is exerted on the wall object 500 depending on the positional relationship between the collision area CA of the left hand object 400L and the wall object 500. Therefore, further improvement of the sense of immersion of the user U in the virtual space 200 is possible.

More specifically, in FIG. 11B, the collision area CA of the left hand object 400L becomes larger as the user U moves the controller 320L a greater distance and at a higher speed (that is, when the user U moves the controller 320L such that D>Dth and V>Vth are satisfied), and thus the amount of the wall object 500 destroyed by the left hand object 400L becomes larger. On the contrary, in FIG. 12B, when the user U moves the controller 320L a shorter distance (when the user U moves the controller 320L so as to satisfy D≦Dth at least), the amount of the wall object 500 destroyed by the left hand object 400L is smaller, and thus the amount of the wall object 500 destroyed in accordance with movement of the user U changes. Therefore, the user U can be immersed in the virtual space more, and a rich virtual experience is provided.

In at least one embodiment, in Step S13, whether or not the distance D>Dth and the relative speed V>Vth are satisfied is determined. In at least one embodiment, only whether or not the distance D>Dth is satisfied may be determined. In this case, when the control unit 121 determines that the distance D>Dth is satisfied, the control unit 121 sets the diameter R of the collision area CA of the left hand object 400L to the diameter R2. On the contrary, when the control unit 121 determines that the distance D≦Dth is satisfied, the control unit 121 sets the diameter R of the collision area CA of the left hand object 400L to the diameter R1. Further, in at least one embodiment, in Step S13, only whether or not the relative speed V>Vth is satisfied may be determined. Also in this case, when the control unit 121 determines that the relative speed V>Vth is satisfied, the control unit 121 sets the diameter R of the collision area CA of the left hand object 400L to the diameter R2. On the contrary, when the control unit 121 determines that the relative speed V≦Vth is satisfied, the control unit 121 sets the diameter R of the collision area CA of the left hand object 400L to the diameter R1.

Further, in Step S13, whether or not a relative acceleration A of the controller 320L with respect to the HMD 110 is larger than a predetermined relative acceleration Ath (A>Ath) is determined. In this case, the control unit 121 identifies the relative acceleration A (example of relative relationship) of the controller 320L with respect to the HMD 110 in the w-axis direction before Step S13.

For example, when the relative speed of the controller 320L with respect to the HMD 110 in the w-axis direction for an n-th frame (n is an integer of 1 or more) is set to Vn+1, the relative speed of the controller 320L with respect to the HMD 110 in the w-axis direction for an (n+1)-th frame is set to Vn+1, and a time interval between frames is set to ΔT, a relative acceleration An in the w-axis direction for the n-th frame is Δn=(Vn−Vn+1)/ΔT.

In this case, when the control unit 121 determines that the relative acceleration A>Ath is satisfied, the control unit 121 sets the diameter R of the collision area CA of the left hand object 400L to the diameter R2. On the contrary, when the control unit 121 determines that the relative acceleration A≦Ath is satisfied, the control unit 121 sets the diameter R of the collision area CA of the left hand object 400L to the diameter R1.

Further, in Step S13, it may be determined whether or not the distance D>Dth and the relative acceleration a>ath are satisfied. Also in this case, when the control unit 121 determines that the distance D>Dth and the relative acceleration A>Ath are satisfied, the control unit 121 sets the diameter R of the collision area CA of the left hand object 400L to the diameter R2. On the contrary, when the control unit 121 determines that the distance D>Dth or the relative acceleration A>Ath is not satisfied, the control unit 121 sets the diameter R of the collision area CA of the left hand object 400L to the diameter R1.

Further, in at least one embodiment, when the determination condition defined in Step S13 is satisfied, the diameter R of the collision area CA of the left hand object 400L is set to the diameter R1. However, when the determination condition is satisfied, the control unit 121 may refer to a table or a function for showing a relationship between the diameter R of the collision area CA and the relative speed V, to thereby change the diameter R (that is, the size of the collision area CA) of the collision area CA in a continuous or stepwise manner depending on the magnitude of the relative speed V. For example, the control unit 121 may increase the diameter R (that is, the size of the collision area CA) of the collision area CA in a continuous or stepwise manner along with increase in relative speed V or relative acceleration A.

Similarly, when the determination condition is satisfied, the control unit 121 may refer to a table or a function for showing a relationship between the diameter R of the collision area CA and the distance D, to thereby change the diameter R (that is, the size of the collision area CA) of the collision area CA in a continuous or stepwise manner depending on the magnitude of the distance D. For example, the control unit 121 may increase the diameter R (that is, the size of the collision area CA) of the collision area CA in a continuous or stepwise manner along with increase in distance D.

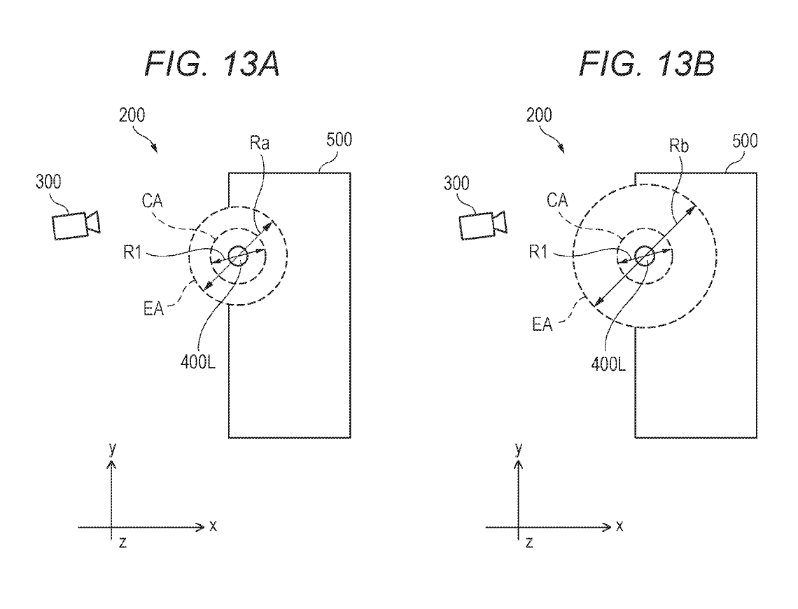

Now, a description is given of an information processing method according to at least one embodiment with reference to FIG. 10 to FIG. 13. FIGS. 13A and 13B represent an effect range EA that exerts an effect on the collision area CA of the left hand object 400L and the wall object 500. The size (diameter) of the collision area CA in FIG. 13A is the same as the size (diameter) of the collision area CA in FIG. 13B, whereas the size (diameter) of the effect range EA in FIG. 13A is smaller than the size (diameter) of the effect range EA in FIG. 13B. In this case, the effect range EA of the left hand object 400L is defined as a range of the left hand object 400L exerting an effect on a target object, for example, the wall object 500.

In the information processing method according to at least one embodiment, when the determination condition defined in Step S13 illustrated in FIG. 10 is satisfied (YES in Step S13), the diameter R of the collision area CA is set to the diameter R2 (Step S14), whereas when the determination condition is not satisfied (NO in Step S13), the diameter R of the collision area CA is set to the diameter R1 (R2>R1) (Step S15).

In contrast, in the information processing method according to the modification example, in response to a determination that the condition defined in Step S13 is satisfied (YES in Step S13), as in FIG. 13B, the diameter R of the collision area CA is set to the diameter R1, whereas the diameter of the effect range EA is set to Rb. On the contrary, when the condition is not satisfied (NO in Step S13), as in FIG. 13A, the diameter R of the collision area CA is set to the diameter R1 and the diameter of the effect range EA is set to Ra (Rb>Ra). In this manner, in the information processing method according to at least one embodiment, the diameter of the collision area CA is not changed but the diameter of the effect range EA is changed depending on the determination condition defined in Step S13.

After that, in Step S16, the control unit 121 determines whether or not the wall object 500 touches the collision area CA or the effect range EA of the left hand object 400L. When the control unit 121 determines that the wall object 500 touches the collision area CA or the effect range EA of the left hand object 400L (YES in Step S16), a predetermined effect is exerted on apart of the wall object 500, which touches the collision area CA or the effect range EA (Step S17). For example, as FIGS. 13A and 13B, the part of the wall object 500, which touches the collision area CA or the effect range EA, is destroyed. Further, because the effect range EA of the left hand object 400L in FIG. 13B is larger than the effect range EA of the left hand object 400L in FIG. 13A (because Rb>Ra), the wall object 500 is destroyed by the left hand object 400L by a larger amount in FIG. 13B than in of FIG. 13A.

On the contrary, when the control unit 121 determines that the wall object 500 does not touch the collision area CA or the effect range EA of the left hand object 400L (NO in Step S16), a predetermined effect is not exerted on the wall object 500.

In this manner, according to at least one embodiment, the effect (collision effect) of the controller 320L exerted on the wall object 500 is set depending on the relative relationship (distance and relative speed) between the HMD 110 and the controller 320L, and thus improving the sense of immersion of the user U in the virtual space 200 is possible. In particular, the size (diameter) of the effect range EA of the left hand object 400L is set depending on the determination condition defined in Step S13. Further, a predetermined effect is exerted on the wall object 500 depending on the positional relationship between the collision area CA and the effect range EA and the wall object 500. Therefore, further improvement of the sense of immersion of the user U in the virtual space 200, and to provide a rich virtual experience is possible.

Further, in order to achieve various types of processing to be executed by the control unit 121 with use of software, information processing instructions for a system for executing the information processing method according to at least one embodiment (using a processor) may be installed in advance into the storage unit 123 or the ROM. Alternatively, the information processing instructions may be stored in a computer-readable storage medium, for example, a magnetic disk (HDD or floppy disk), an optical disc (for example, CD-ROM, DVD-ROM, or Blu-ray Disc®), a magneto-optical disk (for example, MO), and a flash memory (for example, SD card, USB memory, or SSD). In this case, the storage medium is connected to the control device 120, and thus the program stored in the storage medium is installed into the storage unit 123. Then, the information processing instructions installed in the storage unit 123 is loaded onto the RAM, and the processor executes the loaded program. In this manner, the control unit 121 executes the information processing method according to at least one embodiment.

Further, the information processing instructions may be downloaded from a computer on the communication network 3 via the communication interface 125. Also in this case, the downloaded instructions are similarly installed into the storage unit 123.

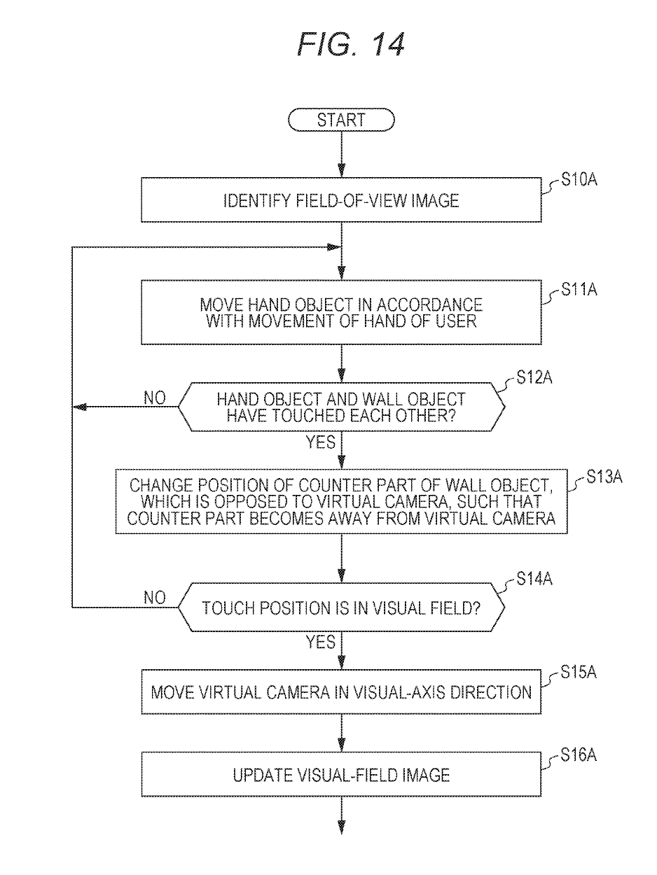

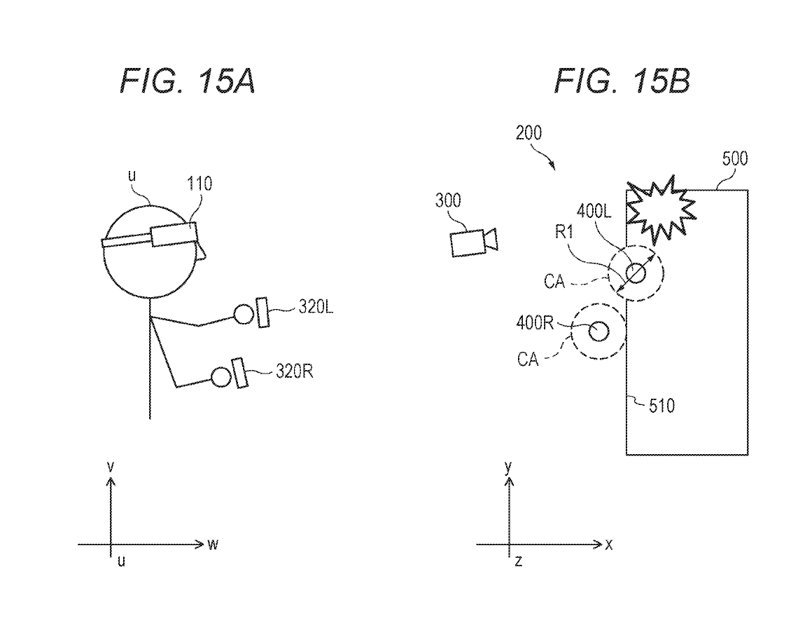

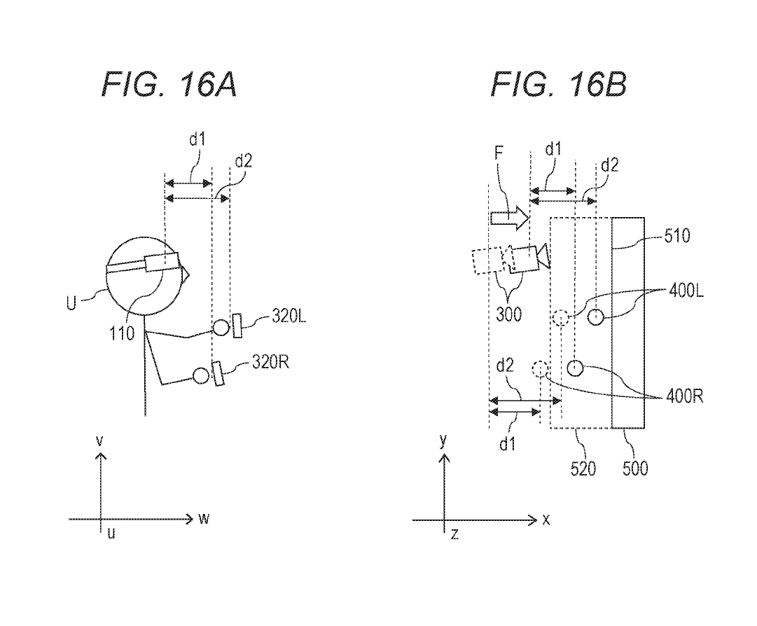

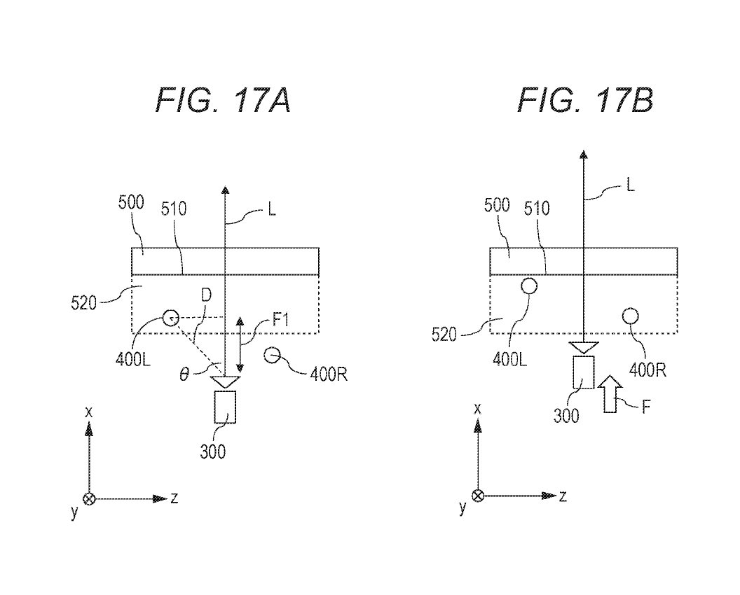

Now, a description is given of an information processing method according to at least one embodiment of this disclosure with reference to FIG. 14 to FIG. 17. FIG. 14 is a flowchart of the information processing method according to at least one embodiment. FIG. 15A is a diagram of how the user U looks forward (+w direction) to move the controller 320L forward according to at least one embodiment. FIG. 15B is a diagram of the wall object 500 destroyed by the left hand object 400L of FIG. 15A. FIG. 16A corresponds to FIG. 15A, and includes a positional relationship between the HMD 110 and the controller 320 according to at least one embodiment. FIG. 16B includes a change in state of the wall object 500 and the virtual camera 300 when the wall object 500 is destroyed according to at least one embodiment. FIG. 17A includes a state after the wall object 500 is destroyed and before the virtual camera 300 is moved from the viewpoint of a Y direction in the virtual space 200 according to at least one embodiment. FIG. 17B includes a state after the wall object 500 is destroyed and after the virtual camera 300 is moved from the viewpoint of the Y direction in the virtual space 200 according to at least one embodiment.

In FIG. 14, in Step S10A, a visual-field image to be presented on the HMD 110 is identified. In at least one embodiment, as in FIG. 15B, the wall object 500 and the hand objects 400L and 400R are present forward of the virtual camera 300. Therefore, as in FIG. 8, a counter part 510 of the wall object 500, which is a surface opposed to the virtual camera 300, is displayed on the visual-field image M. There are the hand objects 400L and 400R between the wall object 500 and the virtual camera 300 in the visual field, and thus the hand objects 400L and 400R are displayed on the visual-field image M so as to be superimposed on the counter part 510.

In Step S11A, the control unit 121 moves the hand object 400 as described above based on movement of the hand of the user U, which is detected by the controller 320.

In Step S12A, the control unit 121 determines whether or not the wall object 500 and the hand object 400 satisfy a predetermined condition. In at least one embodiment, the control unit 121 determines whether or not each hand object 400 has touched the wall object 500 based on the collision area CA set to the left hand object 400L and the right hand object 400R. When each hand object 400 has touched the wall object 500, the processing proceeds to Step S13A. When each hand object 400 does not touch the wall object 500, the control unit 121 waits for information on movement of the hand of the user again, and continues to control movement of the hand object 400.

In Step S13A, the control unit 121 changes the position of the counter part 510 of the wall object 500, which is opposed to the virtual camera 300, such that the counter part 510 becomes away from the virtual camera 300. In at least one embodiment, as in FIG. 15B, the left hand object 400L touches the wall object 500 based on movement of the left hand of the user U so that a part of the wall object 500 is destroyed as FIG. 16B. Specifically, a part of the area including the counter part 510 within the wall object 500 is deleted so that the wall object 500 changes to form a new counter part 510 in the visual-axis direction (+w direction) of the virtual camera 300. With this, the user can get such a virtual experience that a part of the wall object 500 is destroyed by moving his or her left hand.

In Step S14A, the control unit 121 determines whether or not a position at which the hand object 400 and the wall object 500 have touched each other is located within the visual field of the virtual camera 300. When the position is located within the visual field, the processing proceeds to Step S15A, and the control unit 121 executes processing of moving the virtual camera 300. When the position is not located within the visual field, the control unit 121 waits for information on movement of the hand of the user again, and continues to control movement of the hand object 400.

In Step S15A, the control unit 121 moves the virtual camera 300 without association with movement of the HMD 110. Specifically, as in FIG. 16B, the control unit 121 moves the virtual camera 300 forward in the visual-axis direction (+w direction) of the virtual camera 300, in which the wall object 500 is destroyed. When the user U destroys a first part of the wall object 500, the user U further takes an action to destroy remain parts of the wall object 500. In this case, the counterpart 510 moves backward with respect to the virtual camera 300, and thus the user U needs to move the virtual camera 300 forward because the user U cannot reach the wall object 500 with the hand object 400 even when the user U extends his or her arm. In at least one embodiment, providing an intuitive feeling of operation while reducing the time and effort of the user U without the necessity for the user U to perform an operation of moving the HMD 110 forward is possible, that is, by the user U moving the virtual camera 300 to approach the wall object 500 without association with movement of the HMD 110.

In at least one embodiment, when the virtual camera 300 is moved, the hand object 400 be moved in accordance with movement of the virtual camera 300 so as to reflect a relative positional relationship between the HMD 110 and the hand. For example, as in FIG. 16A, a distance d2 between the HMD 110 and the left hand (left hand controller 320L) in the +w direction and a distance d1 between the HMD 110 and the right hand (right hand controller 320R) in the +w direction are assumed in the real space. In this case, as in FIG. 16B, the distance between the virtual camera 300 and the left hand object 400L before movement in the +x direction is set to d2, and the distance between the virtual camera 300 and the right hand object 400R before movement in the +x direction is set to d1. When a movement vector F, which is defined by the movement direction and the movement amount of the virtual camera as described above, is specified, the hand object 400 is moved in accordance with movement of the virtual camera 300. In other words, the distance between the virtual camera 300 and the left hand object 400L after movement in the +x direction is set to d2, and the distance between the virtual camera 300 and the right hand object 400R after movement in the +x direction is set to d1. Through such movement of the hand object 400, the user U can continue to mutually interact with a target object intuitively via the hand object 400 even after movement. The same holds true for the relative positional relationship in directions other than the w direction and the w direction.

In at least one embodiment, when the hand object 400 is moved in accordance with movement of the virtual camera 300, the virtual camera 300 be moved such that the hand object 400 does not touch the wall object 500. For example, as in FIG. 16B, the magnitude of the movement vector F is set such that the hand object 400 (and collision area CA thereof) is set so as to be positioned on the front side of the wall object 500 in the +x direction. With this, preventing occurrence of change in the wall object 500 is possible and movement of the virtual camera 300 that are not intended by the user U due to the hand object 400 touching the wall object 500 again and the counter part 510 moving backward again after movement of the virtual camera 300.

Now, a description is given of an example of setting the movement vector F in at least one embodiment with reference to FIGS. 17A and 17B. FIGS. 17A and 17B is a diagram of the state before and after movement of the virtual camera 300 from the viewpoint of the Y direction in the virtual space 200 according to at least one embodiment. In FIG. 17A, the left hand object 400L and the wall object 500 have touched each other so that the counter part 510 moved backward.

In at least one embodiment, the direction of the movement vector F of the virtual camera 300 be a direction of extension of the visual axis L of the virtual camera 300 at the time when the virtual camera 300 and the left hand object 400L have touched each other regardless of the positional relationship between the virtual camera 300 and the left hand object 400L. With this, the virtual camera 300 is moved in the forward direction with respect to the user U, and the user U is more likely to predict the movement direction. As a result, reducing visually induced motion sickness (so-called VR sickness) caused by movement of the virtual camera 300 and suffered by the user U is possible. In at least one embodiment, even when the virtual camera 300 starts to move and the user U moves his or her head before completion of the movement so that the direction of the virtual camera changes, the virtual camera 300 be moved in the direction of extension of the visual axis L of the virtual camera 300 at the time when the virtual camera 300 and the left hand object 400L have touched each other. With this, the user U is more likely to predict the movement direction, and the VR sickness is reduced.

The magnitude of the movement vector F of the virtual camera 300 is set smaller as the position at which the left hand object 400L and the wall object 500 have touched each other becomes more away from the visual axis L of the virtual camera 300. With this, even when the virtual camera 300 is moved in the direction of the visual axis L, preventing the left hand object 400L from touching the wall object 500 again after movement of the virtual camera 300 is possible.

In FIG. 17A, the distance between the position at which the left hand object 400L and the wall object 500 have touched each other and the visual axis L of the virtual camera 300 may be defined based on an angle θ between the direction from the virtual camera 300 to the left hand object 400L and the visual axis L. When the distance between the position at which the left hand object 400L touches the wall object 500 and the position of the virtual camera 300 is set to D, a distance F1 defined by D*cos θ is obtained. The magnitude of the movement vector F becomes smaller as the position at which the left hand object 400L touches the wall object 500 becomes more away from the visual axis L of the virtual camera 300 by defining the magnitude of the movement vector F as αD*cos θ (α is a constant of 0<α<1).

In Step S16A, the control unit 121 updates the visual-field image based on the visual field of the moved virtual camera 300. The user U can experience movement in the virtual space by being presented with the updated visual-field image on the HMD 110.

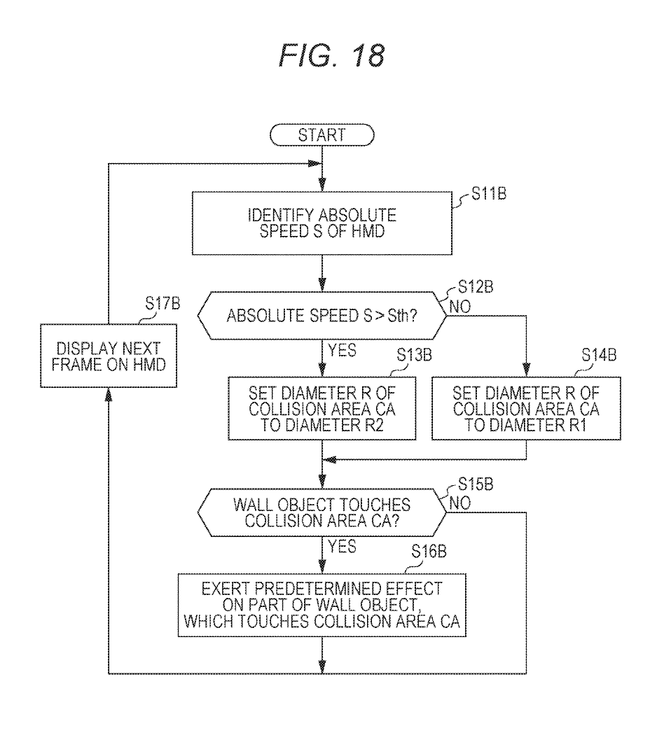

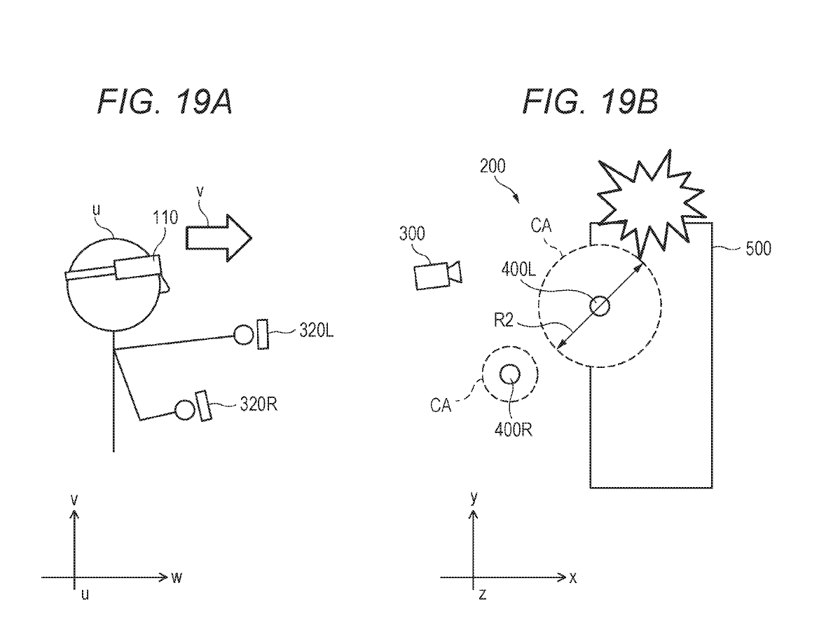

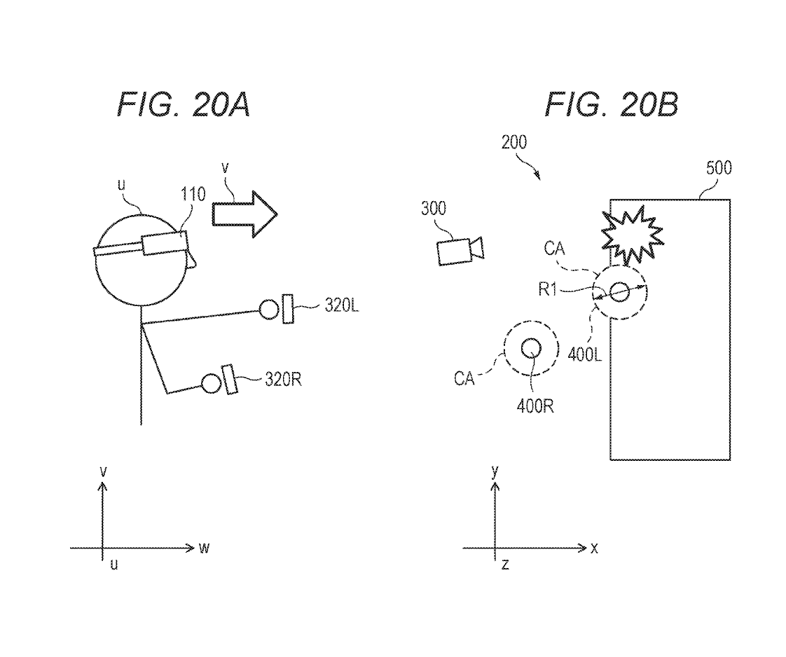

Now, a description is given of an information processing method according to at least one embodiment of this disclosure with reference to FIG. 18 to FIG. 20. FIG. 18 is a flowchart of the information processing method according to at least one embodiment. FIG. 19A is a diagram of how the user U moves forward (+w direction) at an absolute speed S faster than a predetermined speed Sth according to at least one embodiment. FIG. 19B is a diagram of the wall object 500 destroyed by the left hand object 400L in FIG. 19A according to at least one embodiment. FIG. 20A is a diagram of how the user U moves forward (+w direction) at an absolute speed S slower than the predetermined speed Sth according to at least one embodiment. FIG. 20B is a diagram of the wall object 500 destroyed by the left hand object 400L in FIG. 20A according to at least one embodiment.

In the information processing method according to at least one embodiment, the control unit 121 is configured to seta collision effect for defining an effect exerted by the controller 320L on the wall object 500, and set a collision effect for defining an effect exerted by the controller 320R on the wall object 500. Meanwhile, the controllers 320L and 320R have substantially the same configuration, and thus, in the following, only the collision effect for defining an effect exerted by the controller 320L on the wall object 500 is described for the sake of convenience of description. Further, the control unit 121 executes processing steps in FIG. 18 for each frame (still image constructing moving image). Instead, the control unit 121 may execute the processing steps illustrated in FIG. 18 at predetermined time intervals.

In FIG. 18, in Step S11B, the control unit 121 identifies an absolute speed S of the HMD 110. The absolute speed S indicates the speed of the HMD 110 with respect to the position sensor 130 installed at a predetermined position in the real space. Further, the user U wears the HMD 110, and thus the absolute speed of the HMD 110 corresponds to the absolute speed of the user U. That is, in at least one embodiment, the absolute speed of the user U is identified through identification of the absolute speed of the HMD 110.

Specifically, the control unit 121 acquires the position information on the HMD 110 based on the information acquired from the position sensor 130, and identifies the absolute speed S of the HMD 110 in the w axis direction of the HMD 110 based on the acquired position information. In at least one embodiment, the control unit 121 identifies the absolute speed S of the HMD 110 in the w axis direction, but may identify the absolute speed S of the HMD 110 in a predetermined direction other than the w axis direction.

For example, when the position in the w axis direction of a position Pn of the HMD 110 for an n-th frame (n is an integer of 1 or more) is set to wn, the position in the w axis direction of a position Pn+1 of the HMD 110 for an (n+1)-th frame is set to wn+1, and a time interval between frames is set to ΔT, the absolute speed Sn of the HMD 110 in the w-axis direction for the n-th frame is Vn=(wn+1−wn)/ΔT. When the frame rate of the moving image is 90 fps, AT is 1/90.

Next, in Step S12B, the control unit 121 determines whether or not the identified absolute speed S of the HMD 110 is larger than the predetermined speed Sth. The predetermined speed Sth may be set appropriately depending on details of a game. When the control unit 121 determines that the identified absolute speed S is larger than the predetermined speed Sth (S>Sth) (YES in Step S12B), as in FIG. 19B, the control unit 121 sets the diameter R of the collision area CA of the left hand object 400L to the diameter R2 (Step S13B). On the contrary, when the control unit 121 determines that the identified absolute speed S is equal to or smaller than the predetermined speed Sth (S≦Sth) (NO in Step S12B), as illustrated in FIG. 20B, the control unit 121 sets the diameter R of the collision area CA of the left hand object 400L to the diameter R1 (R1<R2) (Step S14B). In this manner, the size of the collision area CA is set depending on the absolute speed S of the HMD 110. In Step S13B and Step S14B, the radius of the collision area CA may be set depending on the absolute speed S instead of the diameter of the collision area CA. Further, when the predetermined speed Sth=0 is satisfied, the control unit 121 executes the processing of Step S13B when determining that the HMD 110 is moving in the +w direction, whereas the control unit 121 executes the processing of Step S14B when determining that the HMD 110 is not moving in the +w direction.

Next, in Step S15B, the control unit 121 determines whether or not the wall object 500 touches the collision area CA of the left hand object 400L. When the control unit 121 determines that the wall object 500 touches the collision area CA of the left hand object 400L (YES in Step S15B), a predetermined effect is exerted on a part of the wall object 500, which touches the collision area CA (Step S16B). For example, the part of the wall object 500, which touches the collision area CA, may be destroyed, or the wall object 500 may be damaged by a predetermined amount. As in FIG. 19B, the part of the wall object 500, which touches the collision area CA of the left hand object 400L, is destroyed. Further, because the collision area CA of the left hand object 400L in FIG. 19B is larger than the collision area CA of the left hand object 400L in FIG. 20B (because R2>R1), the wall object 500 is destroyed by the left hand object 400L by a larger amount in FIG. 19B than in FIG. 20B.

On the contrary, when the control unit 121 determines that the wall object 500 does not touch the collision area CA of the left hand object 400L (NO in Step S15B), a predetermined effect is not exerted on the wall object 500. After that, the control unit 121 updates virtual space data for defining the virtual space including the wall object 500, and displays a next frame (still image) on the HMD 110 based on the updated virtual space data (Step S17B). After that, the processing returns to Step S11B.

In this manner, according to at least one embodiment, the collision effect for defining an effect exerted by the controller 320L on the wall object 500 is set depending on the absolute speed S of the HMD 110. In particular, when the absolute speed S of the HMD 110 is equal to or smaller than the predetermined speed Sth, the collision effect in FIG. 20B is obtained, whereas, when the absolute speed S of the HMD 110 is larger than the predetermined speed Sth, the collision effect as in FIG. 19B is obtained. In this manner, different collision effects are set depending on the absolute speed S of the HMD 110 (that is, the absolute speed of the user U), and thus improving the sense of immersion of the user U in the virtual space, and to provide a rich virtual experience is possible.

More specifically, the collision area CA of the left hand object 400L is set depending on the absolute speed S of the HMD 110. In particular, when the absolute speed S of the HMD 110 is equal to or smaller than the predetermined speed Sth, the diameter R of the left hand object 400L is set to R1, whereas, when the absolute speed S of the HMD 110 is larger than the predetermined speed Sth, the diameter R of the left hand object 400L is set to R2 (R1<R2). Further, a predetermined effect is exerted on the wall object 500 depending on the positional relationship between the collision area CA of the left hand object 400L and the wall object 500. Therefore, further improvement of the sense of immersion of the user U in the virtual space 200 is possible.

In this respect, as in FIGS. 19A and 19B, when the user U (or the HMD 110) moves in thew axis direction such that v>vth is satisfied, the collision area CA of the left hand object 400L becomes larger, and thus the amount of the wall object 500 destroyed by the left hand object 400L becomes larger. On the contrary, as in FIGS. 20A and 20B, when the user U (or the HMD 110) moves in the w axis direction such that V≦Vth is satisfied, the collision area CA of the left hand object 400L becomes smaller, and thus the amount of the wall object 500 destroyed by the left hand object 400L becomes smaller. As a result, the amount of the wall object 500 destroyed in accordance with movement of the user U changes, and thus the user U can be immersed in the virtual space more.

In at least one embodiment, in Step S12B, a determination is made whether or not the absolute speed S of the HMD 110 in the w axis direction is larger than the predetermined speed Sth, but in at least one embodiment a determination is made whether or not the absolute speed S of the HMD 110 in the w axis direction is larger than the predetermined speed Sth and the relative speed V of the controller 320L with respect to the HMD 110 in the movement direction of the HMD 110 (in this example, w axis direction) is larger than the predetermined relative speed Vth. That is, a determination is made whether or not S>Sth and V>Vth are satisfied. The predetermined relative speed Vth may be set appropriately depending on details of a game.

In this case, the control unit 121 identifies the relative speed V of the controller 320L with respect to the HMD 110 in the w axis direction before Step S12B. For example, when the distance between the HMD 110 and the controller 320L in the w axis direction for the n-th frame (n is an integer of 1 or more) is set to Dn, the distance between the HMD 110 and the controller 320L in the w axis direction for the (n+1)-th frame is set to Dn+1, and a time interval between frames is set to ΔT, the relative speed Vn in the w axis direction for the n-th frame is Vn=(Dn−Dn+1)/ΔT.

When the control unit 121 determines that the absolute speed S of the HMD 110 in the w axis direction is larger than the predetermined speed Sth (S>Sth) and the relative speed V of the controller 320L with respect to the HMD 110 in the movement direction of the HMD 110 (w axis direction) is larger than the predetermined relative speed Vth (V>Vth), the control unit 121 sets the diameter R of the collision area CA of the left hand object 400L to the diameter R2. On the contrary, when the control unit 121 determines that v>vth or V>Vth is not satisfied, the control unit 121 sets the diameter R of the collision area CA of the left hand object 400L to the diameter R2. In this manner, the collision effect is set depending on the absolute speed S of the HMD 110 and the relative speed V of the controller 320L with respect to the HMD 110. Therefore, further improvement the sense of immersion of the user U in the virtual space 200 is possible.

Further, in Step S12B, a determination is made whether or not the absolute speed S of the HMD 110 in the w axis direction is larger than the predetermined speed Sth and the relative acceleration a of the controller 320L with respect to the HMD 110 in the movement direction of the HMD 110 (in this example, w axis direction) is larger than the predetermined relative acceleration Ath.

In this case, the control unit 121 identifies the relative acceleration A of the controller 320L with respect to the HMD 110 in the w axis direction before Step S12B. For example, when the relative speed of the controller 320L with respect to the HMD 110 in the w axis direction for the n-th frame (n is an integer of 1 or more) is set to Vn, the relative speed of the controller 320L with respect to the HMD 110 in thew axis direction for the (n+1)-th frame is set to Vn+1, and a time interval between frames is set to ΔT, the relative acceleration an in the w axis direction for the n-th frame is An=(Vn−Vn+1)/ΔT.

When the control unit 121 determines whether or not the absolute speed S of the HMD 110 in the w axis direction is larger than the predetermined speed Sth (S>Sth) and the relative acceleration a of the controller 320L with respect to the HMD 110 in the movement direction of the HMD 110 (w axis direction) is larger than the predetermined relative acceleration Ath (A>Ath), the control unit 121 sets the diameter R of the collision area CA of the left hand object 400L to the diameter R2. On the contrary, when the control unit 121 determines that S>Sth or A>Ath is not satisfied, the control unit 121 sets the diameter R of the collision area CA of the left hand object 400L to the diameter R2. In this manner, the collision effect is set depending on the absolute speed S of the HMD 110 and the relative speed S of the controller 320L with respect to the HMD 110. Therefore, further improvement of the sense of immersion of the user U in the virtual space 200 is possible.

Further, when the determination condition defined in Step S12B is satisfied, the control unit 121 refers to a table or a function for showing a relationship between the diameter R of the collision area CA and the relative speed V, to thereby change the diameter R of the collision area CA (that is, size of collision area CA) in a continuous or stepwise manner depending on the magnitude of the relative speed V. For example, the control unit 121 may increase the diameter R of the collision area CA (that is, size of collision area CA) in a continuous or stepwise manner along with increase in relative speed V.

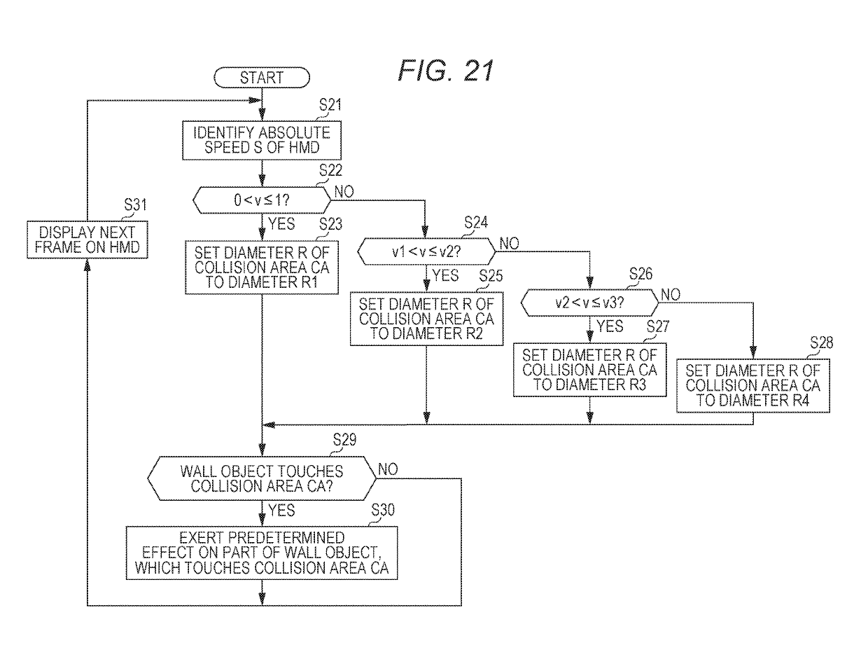

Next, a description is given of an information processing method according to at least one embodiment with reference to FIG. 21. FIG. 21 is a flowchart of the information processing method according at least one embodiment. In FIG. 21, the information processing method according to at least one embodiment is different from the above described information processing method (see FIG. 18) in that the processing of from Step S22 to Step S28 is executed instead of the processing of from Step S12B to Step S14B. The processing of Step S21 and Step S29 to Step S31 in FIG. 21 is therefore the same as that of Step S11B and Step S15B to S17B in FIG. 18, and thus only the processing of from Step S22 to Step S28 is described.

In Step S22, the control unit 121 determines whether or not the absolute speed S of the HMD 110 satisfies 0<S≦S1. When the result of determination in Step S22 is YES, the control unit 121 sets the diameter R of the collision area CA of the left hand object 400L to the diameter R1 (Step S23). On the contrary, when the result of determination in Step S22 is NO, the control unit 121 determines whether or not the absolute speed S of the HMD 110 satisfies S1<S≦S2 (Step S24). When the result of determination in Step S24 is YES, the control unit 121 sets the diameter R of the collision area CA of the left hand object 400L to the diameter R2 (Step S25). On the contrary, when the result of determination in Step S24 is NO, the control unit 121 determines whether or not the absolute speed S of the HMD 110 satisfies S2<S≦S3 (Step S26). When the result of determination in Step S26 is YES, the control unit 121 sets the diameter R of the collision area CA of the left hand object 400L to a diameter R3 (Step S27). On the contrary, when the result of determination in Step S26 is NO, the control unit 121 sets the diameter R of the collision area CA of the left hand object 400L to a diameter R4 (Step S28). In at least one embodiment, the predetermined speeds S1, S2, and S3 are threshold values which satisfy the relationship of 0<S1<S2<S3. Further, in at least one embodiment, the diameters R1, R2, R3, and R4 of the collision area CA satisfy the relationship of R1<R2<R3<R4.

According to at least one embodiment, the control unit 121 can refer to a table or a function for showing a relationship between the diameter R of the collision area CA and the absolute speed S, to thereby change the diameter R of the collision area CA of the left hand object 400L in a stepwise manner depending on the magnitude of the absolute speed S of the HMD 110. Further, according to at least one embodiment, as the absolute speed S of the HMD 110 becomes larger, the collision area CA of the left hand object 400L becomes larger in a stepwise manner. In this manner, as the absolute speed S of the HMD 110 (that is, the absolute speed of the user U) becomes larger, the collision area CA of the left hand object 400L becomes larger. As a result, the collision effect for defining the effect exerted by the left hand object 400L on the wall object 500 becomes larger. Therefore, improving the sense of immersion of the user U in the virtual space, and to provide a rich virtual experience is possible.

The control unit 121 may refer to a table or a function for showing a relationship between the diameter R of the collision area CA and the absolute speed S, to thereby change the diameter R of the collision area CA continuously depending on the magnitude of the relative speed V. Also in this case, further improvement of the sense of immersion of the user U in the virtual space and to provide a rich virtual experience is possible.

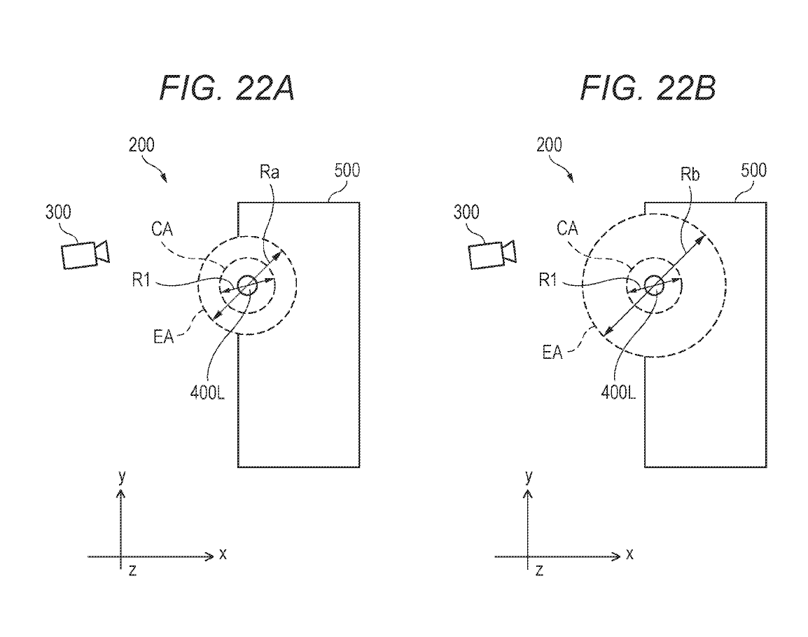

Next, a description is given of an information processing method according to at least one embodiment with reference to FIG. 18 and FIGS. 22A and 22B. FIGS. 22A and 22B are diagrams of the collision area CA of the left hand object 400L and the effect range EA that exerts an effect on the wall object 500. The size (diameter) of the collision area CA in FIG. 22A is the same as the size (diameter) of the collision area CA in FIG. 22B, whereas the size (diameter) of the effect range EA in FIG. 22A is smaller than the size (diameter) of the effect range EA in FIG. 22B. In this case, the effect range EA of the left hand object 400L is defined as the range of an effect exerted by the left hand object 400L on a target object, for example, the wall object 500.

In the information processing method according to at least one embodiment, when the determination condition defined in Step S12B illustrated in FIG. 18 is satisfied (YES in Step S12B), the diameter R of the collision area CA is set to the diameter R2 (Step S13B), whereas, when the determination condition is not satisfied (NO in Step S12B), the diameter R of the collision area CA is set to the diameter R1 (R2>R1) (Step S14B).

In contrast, in the information processing method according to at least one embodiment, when the determination condition defined in Step S12B is satisfied (YES in Step S12B), as in FIG. 22B, the diameter R of the collision area CA is set to the diameter R1 and the diameter of the effect range EA is set to Rb. On the contrary, when the determination condition is not satisfied (NO in Step S12B), as in FIG. 22A, the diameter R of the collision area CA is set to the diameter R1 and the diameter of the effect range EA is set to Ra (Rb>Ra). In this manner, in the information processing method according to at least one embodiment, the diameter of the collision area CA is not changed but the diameter of the effect range EA is changed depending on the determination condition defined in Step S12B.

Next, in Step S15B, the control unit 121 determines whether or not the wall object 500 touches the collision area CA or the effect range EA of the left hand object 400L. When the control unit 121 determines that the wall object 500 touches the collision area CA or the effect range EA of the left hand object 400L (YES in Step S15B), a predetermined effect is exerted on a part of the wall object 500, which touches the collision area CA or the effect range EA (Step S16B). For example, in FIGS. 22A and 22B, the part of the wall object 500, which touches the collision area CA or the effect range EA, is destroyed. Further, because the effect range EA of the left hand object 400L in FIG. 22B is larger than the effect range EA of the left hand object 400L in FIG. 22A (because Rb>Ra), the wall object 500 is destroyed by the left hand object 400L by a larger amount in FIG. 22B than in FIG. 22A.

On the contrary, when the control unit 121 determines that the wall object 500 does not touch the collision area CA or the effect range EA of the left hand object 400L (NO in Step S15B), a predetermined effect is not exerted on the wall object 500.

In this manner, according to at least one embodiment, the effect (collision effect) exerted by the controller 320L on the wall object 500 is set depending on the absolute speed S of the HMD 110, and thus further improvement of the sense of immersion of the user U in the virtual space 200 and to provide a rich virtual experience is possible. In particular, the size (diameter) of the effect range EA of the left hand object 400L is set depending on the determination condition defined in Step S12B. Further, a predetermined effect is exerted on the wall object 500 depending on a positional relationship among the collision area CA, the effect range EA, and the wall object 500. Therefore, further improvement of the sense of immersion of the user U in the virtual space 200, and to provide a rich virtual experience is possible.

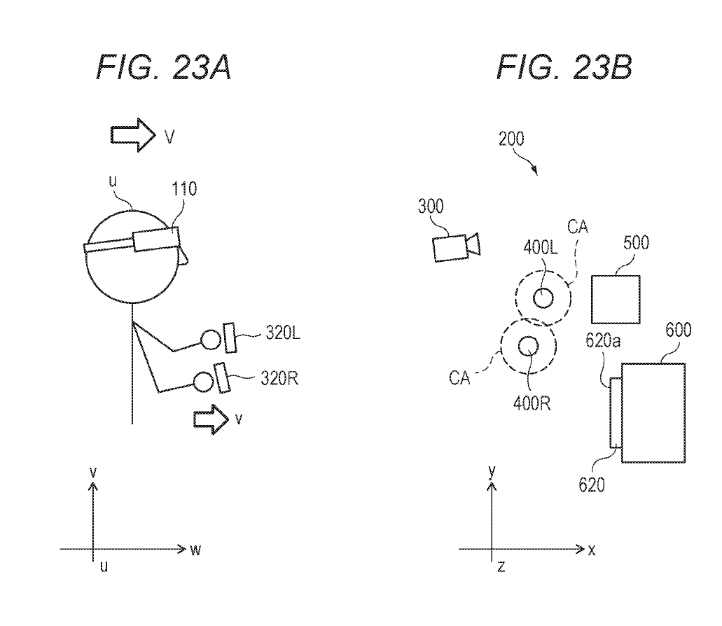

Now, with reference to FIGS. 23A and 23B, a description is given of the left hand object 400L (example of operation object), the right hand object 400R (example of operation object), a block object 500 (virtual object), a button object 600 (example of target object being virtual object), which are included in the virtual space 200. FIG. 23A is a diagram of the user U wearing the HMD 110 and the controllers 320L and 320R according to at least one embodiment. FIG. 23B is a diagram of the virtual space 200 including the virtual camera 300, the left hand object 400L, the right hand object 400R, the block object 500, and the button object 600 according to at least one embodiment.

As described above, the virtual space 200 includes the virtual camera 300, the left hand object 400L, the right hand object 400R, the block object 500, and the button object 600. The control unit 121 generates virtual space data for defining the virtual space 200 including those objects. Further, the control unit 121 may update the virtual space data on a frame basis. As described above, the virtual camera 300 moves in accordance with movement of the HMD 110 worn by the user U. That is, the visual field of the virtual camera 300 is updated in accordance with movement of the HMD 110.

The left hand object 400L moves in accordance with movement of the controller 320L worn on the left hand of the user U. Similarly, the right hand object 400R moves in accordance with movement of the controller 320R worn on the right hand of the user U. In the following, the left hand object 400L and the right hand object 400R may simply be referred to as “hand object 400” for the sake of convenience of description.

Further, the user U can operate the operation button 302 of the external controller 320 to operate each finger of the hand object 400. That is, the control unit 121 acquires an operation signal corresponding to an input operation for the operation button 302 from the external controller 320, and controls operation of each finger of the hand object 400 based on the operation signal. For example, the user U can operate the operation button 302 so that the hand object 400 grasps the block object 500. Further, the hand object 400 and the block object 500 can be moved in accordance with movement of the controller 320 with the hand object 400 holding the block object 500. In this manner, the control unit 121 is configured to control operation of the hand object 400 in accordance with movement of a finger of the user U.

Further, the left hand object 400L and the right hand object 400R each include the collision area CA. The collision area CA is used for determination of collision (determination of hit) between the hand object 400 and a virtual object (for example, block object 500 or button object 600). The collision area CA of the hand object 400 and the collision area of the block object 500 (button object 600) have touched each other so that a predetermined effect (collision effect) is exerted on the block object 500 (button object 600).

For example, a predetermined damage can be given to the block object 500 by the collision area CA of the hand object 400 and the collision area of the block object 500 touching each other. Further, moving the hand object 400 and the block object 500 in an integrated manner with the hand object 400 holding the block object 500 is possible.

In FIG. 23B, the collision area CA may be defined by, for example, a sphere having the center position of the hand object 400 as a center and the diameter R. In the following description, the collision area CA of the hand object 400 is formed to have a sphere shape having the center position of the hand object 400 as its center and the diameter R. In at least one embodiment, the collision area CA has a different shape and/or a different positional relationship with hand object 400.

The block object 500 is a virtual object that the hand object 400 exerts an effect on. The block object 500 also has the collision area, and in at least one embodiment, the collision area of the block object 500 is the same as the area forming the block object 500 (exterior area of block object 500). In at least one embodiment, the collision area of the block object 500 is different from the area forming the block object 500.

The button object 600 is a virtual object that the hand object 400 exerts an effect on, and includes an operation portion 620. The button object 600 also includes the collision area, and in at least one embodiment, the collision area of the button object 600 is the same as the area forming the button object 600 (exterior area of button object 600). In at least one embodiment, the collision area of the operation portion 620 is the same as the exterior area of the operation portion 620.

A predetermined effect is exerted on a predetermined object (not shown) placed in the virtual space 200 when the operation portion 620 of the button object 600 is pressed by the hand object 400. Specifically, the collision area CA of the hand object 400 and the collision area of the operation portion 620 have touched each other so that the operation portion 620 is pressed by the hand object 400 as the collision effect. Then, the operation portion 620 is pressed so that a predetermined effect is exerted on a predetermined object placed in the virtual space 200. For example, an object (character object) present in the virtual space 200 may start to move by the operation portion 620 being pressed by the hand object 400.

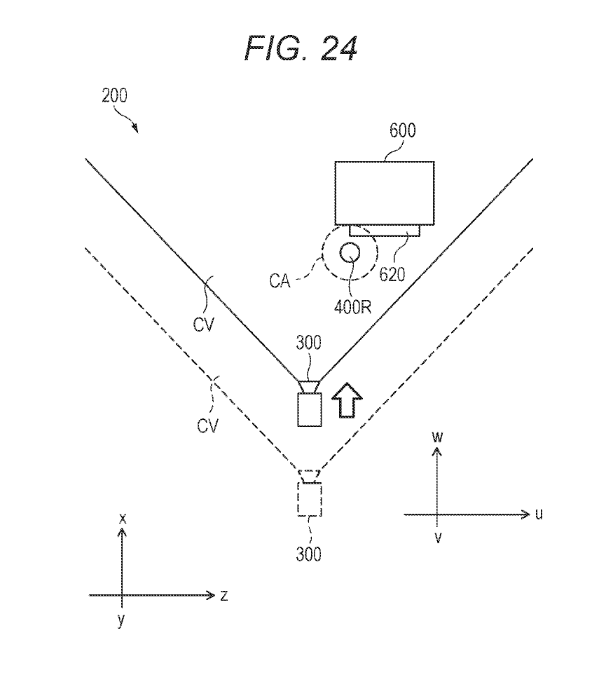

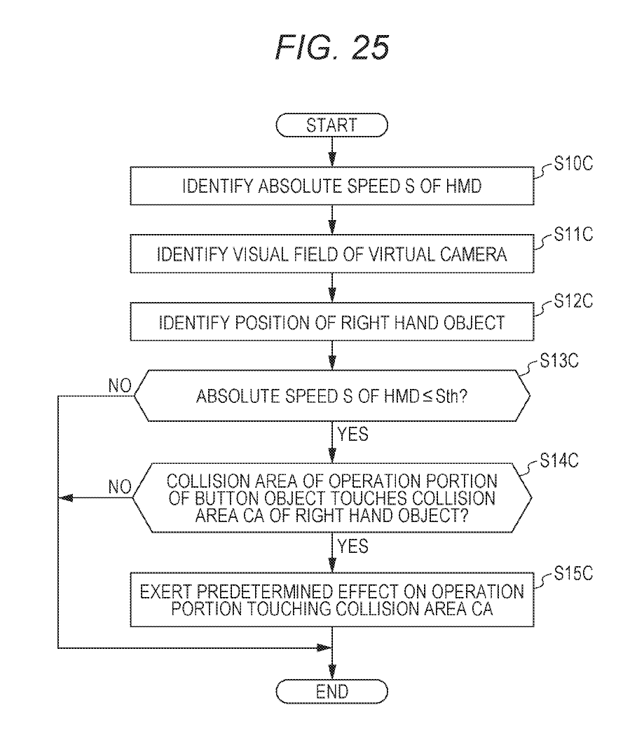

Next, a description is given of an information processing method according to at least one embodiment of this disclosure with reference to FIG. 24 to FIG. 25. FIG. 24 is a plan-view diagram of the virtual space 200 of how the collision area CA of the right hand object 400R touches the operation portion 620 of the button object 600 according to at least one embodiment. FIG. 25 is a flowchart of the information processing method according to at least one embodiment. In the flowchart of FIG. 25, processing of determining whether or not the collision area CA of the right hand object 400R has touched the collision area of the operation portion 620 (determination processing defined in Step S13C) intentionally is executed before determination of hit between the right hand object 400R and the operation portion 620 (processing defined in Step S14C).

Further, in description of at least one embodiment, whether or not the right hand object 400R exerts a predetermined effect on the operation portion 620 of the button object 600 is mentioned for the sake of convenience of description, whereas whether or not the left hand object 400L exerts a predetermined effect on the operation portion 620 of the button object 600 is not mentioned. Thus, in FIG. 24, the left hand object 400L is omitted. Further, the control unit 121 may execute processing steps in FIG. 25 on a frame basis repeatedly. Instead, the control unit 121 may execute the processing steps illustrated in FIG. 25 at predetermined time intervals.

In FIG. 25, in Step S10C, the control unit 121 identifies an absolute speed S (refer to FIG. 23) of the HMD 110. At this time, the absolute speed S refers to the speed of the HMD 110 with respect to the position sensor 130 installed in a fixed manner at a predetermined position in the real space. Further, the user U wears the HMD 110, and thus the absolute speed of the HMD 110 corresponds to the absolute speed of the user U. That is, in at least one embodiment, the absolute speed of the HMD 110 is identified to identify the absolute speed of the user U. In FIG. 24, when the HMD 110 is moved in the real space, the virtual camera 300 also moves in the virtual space 200.

Specifically, the control unit 121 acquires position information on the HMD 110 based on data acquired by the position sensor 130, and identifies the absolute speed S of the HMD 110 based on the acquired position information. For example, when the position of the HMD 110 for an n-th frame (n is an integer of 1 or more) is set to Pn, the position of the HMD 110 for an (n+1)-th frame is set to Pn+1, and a time interval between frames is set to ΔT, the absolute speed Sn of the HMD 110 for the n-th frame is Sn=|Pn+1−Pn|/ΔT. When the frame rate of the moving image is 90 fps, the time interval ΔT is 1/90. Further, a position P of the HMD 110 is a position vector that can be displayed in a three-dimensional coordinate system. In this manner, the control unit 121 can acquire the position Pn of the HMD 110 for an n-th frame and the position Pn+1 of the HMD 110 for an (n+1)-th frame to identify the absolute speed Sn for an n-th frame based on the position vectors Pn and Pn+1 and the time interval ΔT.

The control unit 121 may identify the absolute speed S of the HMD 110 in the w axis direction, or may identify the absolute speed S of the HMD 110 in a predetermined direction other than the w axis direction. For example, when the position in the w axis direction of the position Pn of the HMD 110 for an n-th frame (n is an integer of 1 or more) is set to wn, the position in the w axis direction of a position Pn+1 of the HMD 110 for an (n+1)-th frame is set to wn+1, and a time interval between frames is set to ΔT, the absolute speed Sn of the HMD 110 in the w-axis direction for the n-th frame is Sn=(wn+1−wn)/ΔT.

Next, in Step S11C, the control unit 121 identifies the visual field CV of the virtual camera 300. Specifically, the control unit 121 identifies the position and inclination of the HMD 110 based on data from the position sensor 130 and/or the HMD sensor 114, and identifies the visual field CV of the virtual camera 300 based on the position and inclination of the HMD 110. After that, the control unit 121 identifies the position of the right hand object 400R (Step S12C). Specifically, the control unit 121 identifies the position of the controller 320R in the real space based on data from the position sensor 130 and/or a sensor of the controller 320R, and identifies the position of the right hand object 400R based on the position of the controller 320R in the real space.

Next, the control unit 121 determines whether or not the absolute speed S of the HMD 110 is equal to or smaller than the predetermined value Sth (S≦Sth) (Step S13C). The predetermined value Sth (Sth≧0) may be set appropriately depending on details of content, for example, a game. Further, the determination condition (S≦Sth) defined in Step S13C corresponds to a determination condition (first condition) for determining whether or not the collision area CA of the right hand object 400R (operation object) has touched the collision area of the operation portion 620 of the button object 600 (target object) intentionally.

When the control unit 121 determines whether or not the determination condition defined in Step S13C is not satisfied (that is, when the absolute speed S is determined to be larger than the predetermined value Sth) (NO in Step S13C), the control unit 121 does not execute processing defined in Step S14C and Step S15C. That is, the control unit 121 does not execute collision determination processing defined in Step S14C and processing of causing a collision effect defined in Step S15C, and thus the right hand object 400R does not exert a predetermined effect on the operation portion 620 of the button object 600.

On the contrary, when the control unit 121 determines that the determination condition defined in Step S13C is satisfied (that is, when the absolute speed S is determined to be equal to or smaller than the predetermined value Sth) (YES in Step S13C), the control unit 121 determines whether or not the collision area of the operation portion 620 of the button object 600 touches the collision area CA of the right hand object 400R (Step S14C). In particular, the control unit 121 determines whether or not the collision area of the operation portion 620 touches the collision area CA of the right hand object 400R based on the position of the right hand object 400R and the position of the operation portion 620 of the button object 600. When the result of determination in Step S14C is YES, the control unit 121 exerts a predetermined effect on the operation portion 620 touching the collision area CA of the right hand object 400R (Step S14C). For example, the control unit 121 may determine that the operation portion 620 is pressed by the right hand object 400R as an effect of collision between the right hand object 400R and the operation portion 620. As a result, a predetermined effect may be exerted on a predetermined object (not shown) placed in the virtual space 200. Further, a contact surface 620a of the operation portion 620 may move in the +X direction as an effect of collision between the right hand object 400R and the operation portion 620. On the contrary, when the result of determination in Step S14C is NO, an effect of collision between the right hand object 400R and the operation portion 620 is not caused.

According to at least one embodiment, a determination is made whether or not the absolute speed S of the HMD 110 is equal to or smaller than the predetermined value Sth as a determination condition for determining whether or not the collision area CA of the right hand object 400R touches the collision area of the operation portion 620 intentionally. When the absolute speed S is larger than the predetermined value Sth (when the determination condition of Step S13C is not satisfied), the processing defined in Step S14C and Step S15C is not executed. In this manner, when the right hand object 400R has touched the operation portion 620 with the absolute speed S of the HMD 110 being larger than the predetermined value Sth, the right hand object 400R is determined to have touched the operation portion 620 unintentionally. Thus, determination of collision between the right hand object 400R and the operation portion 620 is not executed, and an effect of collision between the right hand object 400R and the operation portion 620 is not caused.

Therefore, a situation is avoided in which, when the right hand object 400R has touched the operation portion 620 unintentionally, the operation portion 620 is pressed by the right hand object 400R unintentionally. In this manner, further improvement of the virtual experience of the user is possible.

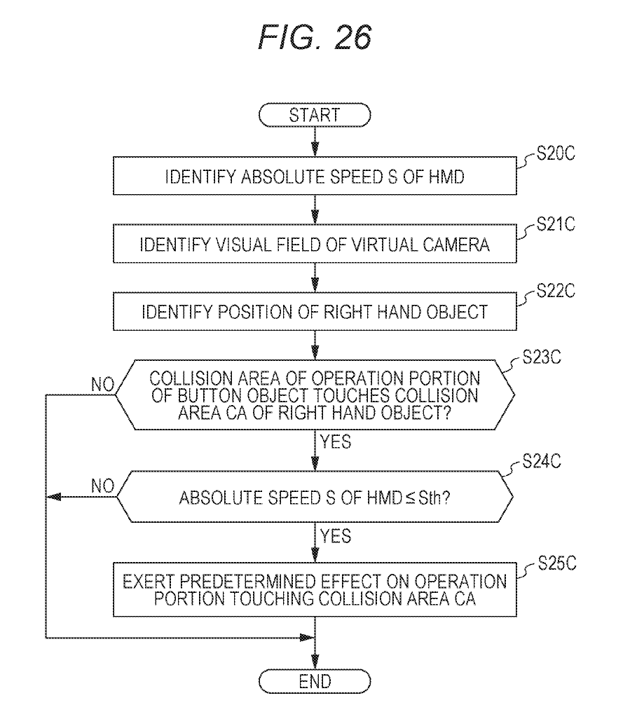

Next, a description is given of an information processing method according to at least one embodiment of this disclosure with reference to FIG. 26. FIG. 26 is a flowchart of an information processing method according to at least one embodiment. In the flowchart of FIG. 26, processing of determining whether or not the collision area CA of the right hand object 400R has touched the collision area of the operation portion 620 intentionally (determination processing defined in Step S24C) is executed after determination of hit between the right hand object 400R and the operation portion 620 (processing defined in Step S23C). In this respect, the information processing method in FIG. 26 and the information processing method in FIG. 25 are different from each other. In the following, only a difference from the information processing method in FIG. 25 is described.

In FIG. 26, the control unit 121 executes processing defined in Step S20C to Step S22C, and then determines whether or not the collision area of the operation portion 620 of the button object 600 touches the collision area CA of the right hand object 400R (Step S23C). The processing of from Step S20C to Step S22C corresponds to the processing of from Step S10C to Step S12C illustrated in FIG. 25.

When the result of determination in Step S23C is NO, the collision area of the operation portion 620 does not touch the collision area CA of the right hand object 400R, and thus the control unit 121 ends this processing. On the contrary, when the result of determination in Step S23C is YES (when it is determined that the collision area of the operation portion 620 touches the collision area CA of the right hand object 400R), the control unit 121 determines whether or not the absolute speed S of the HMD 110 is equal to or smaller than the predetermined value Sth (Step S24C).

When the control unit 121 determines that the absolute speed S is larger than the predetermined value Sth (NO in Step S24C), the control unit 121 ends this processing without executing processing defined in Step S25C. On the contrary, when the control unit 121 determines that the absolute speed S is equal to or smaller than the predetermined value Sth (YES in Step S24C), the control unit 121 exerts a predetermined effect (collision effect) on the operation portion 620 touching the collision area CA of the right hand object 400R (Step S25C).

In this manner, in response to a determination that the absolute speed S is larger than the predetermined value Sth (when the determination condition of Step S24C is not satisfied), the processing defined in Step S25C is not executed. In this manner, when the right hand object 400R has touched the operation portion 620 with the absolute speed S of the HMD 110 being larger than the predetermined value Sth, the right hand object 400R is determined to have touched the operation portion 620 unintentionally, and thus an effect of collision between the right hand object 400R and the operation portion 620 is not caused. In this respect, in the information processing method according to at least one embodiment, determination of collision between the right hand object 400R and the operation portion 620 is executed, whereas an effect of collision between the right hand object 400R and the operation portion 620 is not caused when the result of determination in Step S24C is NO.

Therefore, a situation is avoided in which, when the right hand object 400R has touched the operation portion 620 unintentionally, the operation portion 620 is pressed by the right hand object 400R unintentionally. In this manner, further improvement of the virtual experience of the user is possible.

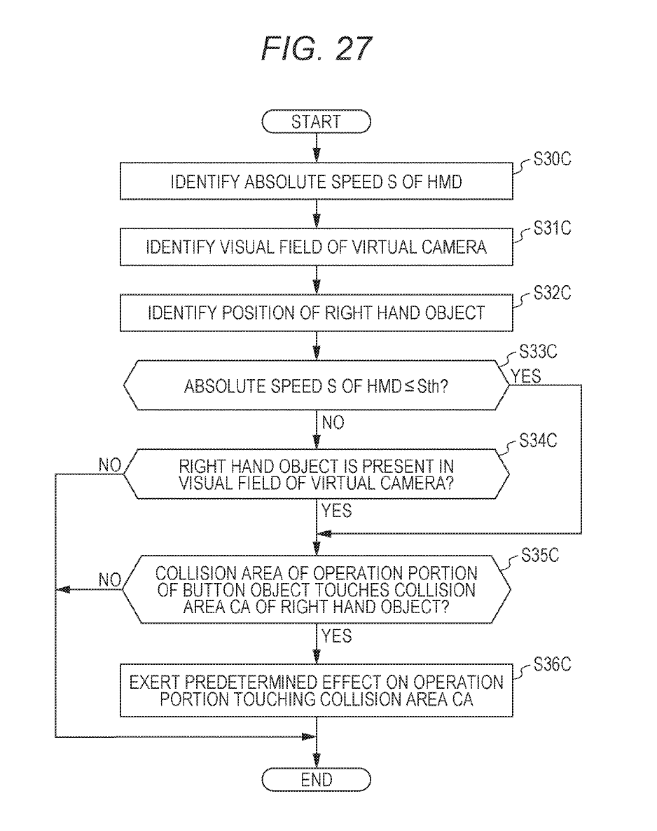

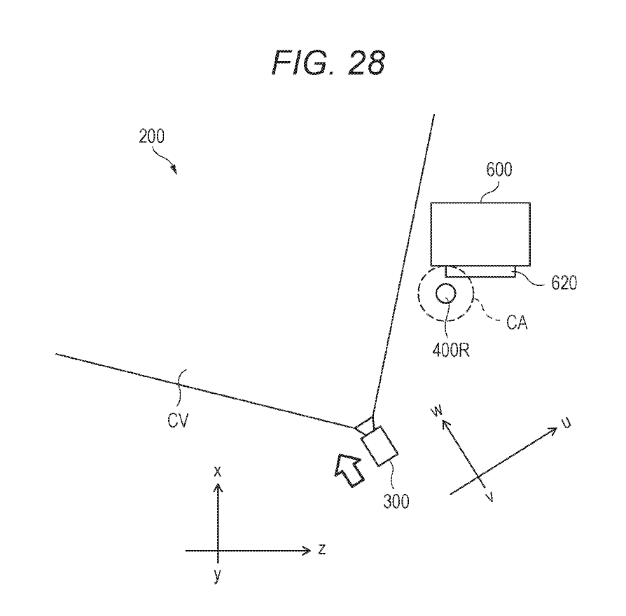

Now, a description is given of an information processing method according to at least one embodiment of this disclosure with reference to FIG. 27 and FIG. 28. FIG. 27 is a flowchart of an information processing method according to at least one embodiment of this embodiment. FIG. 28 is a plan-view diagram of the virtual space 200 for illustrating a state in which the right hand object 400R and the button object 600 are outside the visual field CV of the virtual camera 300 according to at least one embodiment. In FIG. 27, the information processing method according to at least one embodiment is different from the information processing method in FIG. 25 in that the information processing method in FIG. 27 further includes a step defined in Step S34C. In the following, a redundant description is not given of matters already described in the above-mentioned description.

In FIG. 27, the control unit 121 executes processing defined in Step S30C to Step S32C, and then determines whether or not the absolute speed S of the HMD 110 is equal to or smaller than the predetermined value Sth (Step S33C). The processing of from Step S30C to Step S32C corresponds to the processing of from Step S10C to Step S12C in FIG. 25.

When the result of determination in Step S33C is YES, the control unit 121 determines whether or not the collision area of the operation portion 620 of the button object 600 touches the collision area CA of the right hand object 400R (Step S35C). On the contrary, when the result of determination in Step S33C is NO, the control unit 121 determines whether or not the right hand object 400R is present in the visual field CV of the virtual camera 300 based on the visual field CV of the virtual camera 300 and the position of the right hand object 400R (Step S34C). In FIG. 28, when the right hand object 400R is present outside the visual field CV of the virtual camera 300, the control unit 121 determines that the determination condition (second condition) defined in Step S34C is not satisfied, and ends this processing without executing the processing of Step S35C and Step S36C. That is, the control unit 121 does not execute collision determination processing defined in Step S35C and processing of causing a collision effect defined in Step S36C, and thus the right hand object 400R does not exert a predetermined effect on the operation portion 620 of the button object 600. The determination condition defined in Step S34C corresponds to a determination condition (second condition) for determining whether or not the collision area CA of the right hand object 400R has touched the collision area of the operation portion 620 intentionally.

On the contrary, when the control unit 121 determines that the determination condition defined in Step S34C is satisfied (that is, in response to a determination that the right hand object 400R is present in the visual field CV of the virtual camera 300) (YES in Step S34C), the control unit 121 executes the determination processing (collision determination processing) of Step S35C. When the result of determination in Step S35C is YES, the control unit 121 exerts a predetermined effect on the operation portion 620 touching the collision area CA of the right hand object 400R (Step S36C). On the contrary, when the result of determination in Step S35C is NO, the control unit 121 ends this processing without executing the processing of Step S36C.

According to at least one embodiment, as determination conditions for determining whether or not the collision area CA of the right hand object 400R touches the collision area of the operation portion 620 intentionally, a determination is made whether or not the absolute speed S of the HMD 110 is equal to or smaller than the predetermined value Vth (Step S33C), and a determination is made whether or not the right hand object 400R is present in the visual field CV of the virtual camera 300 (Step S34C). Further, in response to a determination that none of the determination condition of Step S33C and the determination condition of Step S34C is satisfied, the right hand object 400R does not exert a predetermined effect on the operation portion 620. In this manner, through use of two different determination conditions, whether or not the right hand object 400R has touched the operation portion 620 unintentionally is more reliably determined. In particular, when the right hand object 400R has touched the operation portion 620 under a state in which the absolute speed S of the HMD 110 is larger than the predetermined value Sth and the right hand object 400R is not present in the visual field CV, a determination is made that the right hand object 400R has touched the operation portion 620 unintentionally, and an effect of collision between the right hand object 400R and the operation portion 620 is not caused. Therefore, when the right hand object 400R has touched the operation portion 620 unintentionally, a situation in which the operation portion 620 is pressed by the right hand object 400R unintentionally can be avoided. In this manner, further improvement of the virtual experience of the user is possible.

In at least one embodiment, in Step S34C, the control unit 121 determines whether or not the right hand object 400R is present in the visual field CV. Instead, the control unit 121 may determine whether or not at least one of the right hand object 400R and the button object 600 is present in the visual field CV. In this case, when the right hand object 400R has touched the operation portion 620 under a state in which the absolute speed S of the HMD 110 is larger than the predetermined value Vth and the right hand object 400R and the button object 600 are both not present in the visual field CV, a determination is made that the right hand object 400R has touched the operation portion 620 unintentionally, and an effect of collision between the right hand object 400R and the operation portion 620 is not caused.

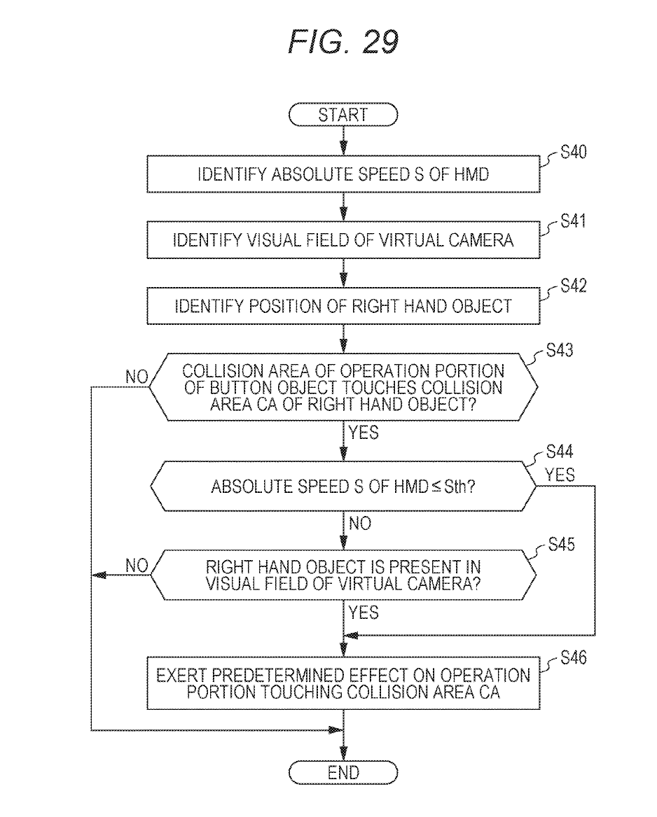

Now, a description is given of an information processing method according to at least one embodiment of this disclosure with reference to FIG. 29. FIG. 29 is a flowchart of an information processing method according to at least one embodiment. In FIG. 29, processing of determining whether or not the collision area CA of the right hand object 400R has touched the collision area of the operation portion 620 intentionally (determination processing defined in Step S44 and Step S45) is executed after determination of hit between the right hand object 400R and the operation portion 620 (processing defined in Step S43C). In this respect, the information processing method in FIG. 29 and the information processing method in FIG. 27 are different from each other. In the following, only a difference from the information processing method in FIG. 27 is described.

In FIG. 29, the control unit 121 executes processing defined in Step S40 to Step S42, and then determines whether or not the collision area of the operation portion 620 of the button object 600 touches the collision area CA of the right hand object 400R (Step S43).

When the result of determination in Step S43 is NO, the collision area of the operation portion 620 does not touch the collision area CA of the right hand object 400R, and thus the control unit 121 ends this processing. On the contrary, when the result of determination in Step S43 is YES (when the collision area of the operation portion 620 touches the collision area CA of the right hand object 400R), the control unit 121 determines whether or not the absolute speed S of the HMD 110 is equal to or smaller than the predetermined value Sth (Step S44).

When the control unit 121 determines that the absolute speed S is larger than the predetermined value Sth (NO in Step S44), the control unit 121 executes determination processing defined in Step S45. On the contrary, when the control unit 121 determines that the absolute speed S is equal to or smaller than the predetermined value Sth (YES in Step S44), the control unit 121 exerts a predetermined effect (collision effect) on the operation portion 620 touching the collision area CA of the right hand object 400R (Step S46).

When the control unit 121 determines that the right hand object 400R is present in the visual field CV of the virtual camera 300 (YES in Step S45), the control unit 121 exerts a predetermined effect (collision effect) on the operation portion 620 touching the collision area CA of the right hand object 400R (Step S46). On the contrary, when the result of determination in Step S45 is NO, the control unit 121 ends this processing without executing the processing of Step S46.

In the information processing method according to at least one embodiment, determination of collision between the right hand object 400R and the operation portion 620 is executed, but when none of the determination condition of Step S44 and the determination condition of Step S45 is satisfied, an effect of collision between the right hand object 400R and the operation portion 620 is not caused.

Therefore, a situation is avoided in which, when the right hand object 400R has touched the operation portion 620 unintentionally, the operation portion 620 is pressed by the right hand object 400R unintentionally. In this manner, further improvement of the virtual experience of the user is possible.

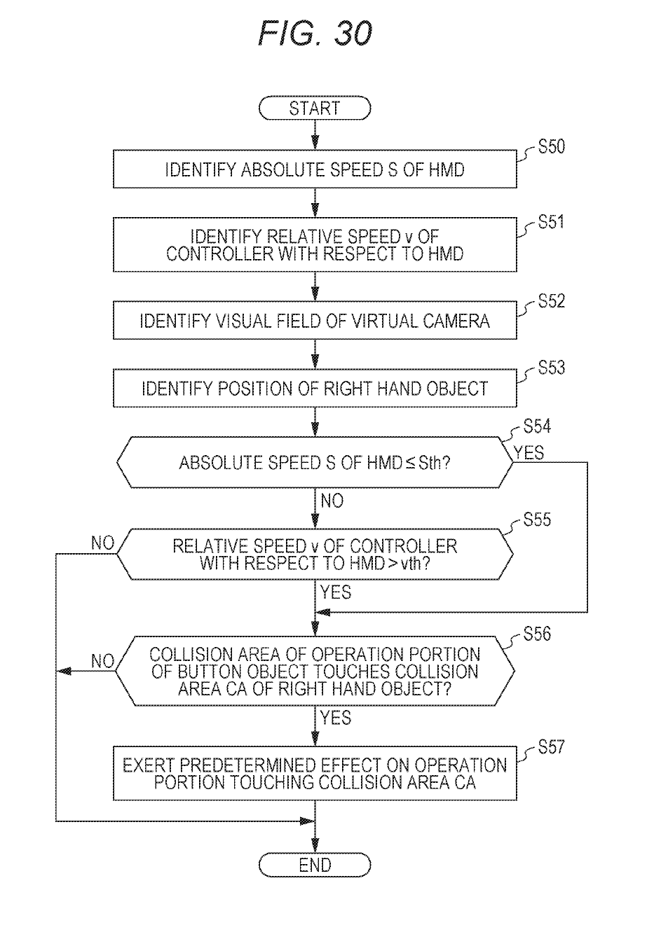

Now, a description is given of an information processing method according to at least one embodiment of this disclosure with reference to FIG. 30. FIG. 30 is a flowchart of an information processing method according at least one embodiment of this disclosure. In FIG. 30, the information processing method according to at least one embodiment is different from the information processing method in FIG. 25 in that the information processing method according to at least one embodiment further includes steps defined in Step S51 and Step S55. In the following, a redundant description is not given of matters that are already described.

In FIG. 30, the control unit 121 executes processing defined in Step S50, and then identifies the relative speed v (refer to FIG. 23) of the controller 320R (right hand of user U) with respect to the HMD 110 (Step S51). For example, as described above, the position of the HMD 110 for an n-th frame (n is an integer of 1 or more) is set to Pn, the position of the HMD 110 for an (n+1)-th frame is set to Pn+1, and a time interval between frames is set to ΔT, the absolute speed Sn of the HMD 110 for the n-th frame is Sn=|Pn+1−Pn|/ΔT. Further, when the position of the controller 320R for an n-th frame is set to P′n, the position of the controller 320R for an (n+1)-th frame is set to P′n+1, and a time interval between frames is set to ΔT, an absolute speed S′n of the controller 320R for the n-th frame is S′n=|P′n+1−P′n|/ΔT. Thus, the relative speed Vn of the controller 320R with respect to the HMD 110 for the n-th frame is Vn=S′n−Sn. In this manner, the control unit 121 can identify the relative speed Vn for an n-th frame based on the absolute speed Sn of the HMD 110 and the absolute speed S′n of the controller 320R for an n-th frame. The control unit 121 may identify the relative speed V in the w axis direction, or may identify the relative speed V in a predetermined direction other than the w axis direction.

Next, the control unit 121 executes processing defined in Step S52 and Step S53, and then determines whether or not the absolute speed S of the HMD 110 is equal to or smaller than the predetermined value Sth (Step S54).

When the result of determination in Step S54 is YES, the control unit 121 determines whether or not the collision area of the operation portion 620 of the button object 600 touches the collision area CA of the right hand object 400R (Step S56). On the contrary, when the result of determination in Step S54 is NO, the control unit 121 determines whether or not the relative speed V of the controller 320R with respect to the HMD 110 is larger than the predetermined value Vth (Step S55). The predetermined value Vth (Vth≧0) can be set appropriately depending on details of content, for example, a game. When the result of determination in Step S55 is NO, the control unit 121 ends this processing without executing processing of Step S56 and Step S57. That is, the control unit 121 does not execute collision determination processing defined in Step S56 and processing of causing a collision effect defined in Step S57, and thus the right hand object 400R does not exert a predetermined effect on the operation portion 620 of the button object 600. The determination condition defined in Step S55 corresponds to a determination condition (second condition) for determining whether or not the collision area CA of the right hand object 400R has touched the collision area of the operation portion 620 intentionally.

On the contrary, when the control unit 121 determines that the determination condition defined in Step S55 is satisfied (that is, when it is determined that the relative speed V is larger than the predetermined value Vth) (YES in Step S55), the control unit 121 executes the determination processing (collision determination processing) of Step S56. When the result of determination in Step S56 is YES, the control unit 121 exerts a predetermined effect on the operation portion 620 touching the collision area CA of the right hand object 400R (Step S57). On the contrary, when the result of determination in Step S56 is NO, the control unit 121 ends this processing without executing the processing of Step S57.

According to at least one embodiment, as determination conditions for determining whether or not the collision area CA of the right hand object 400R touches the collision area of the operation portion 620 intentionally, whether or not the absolute speed S of the HMD 110 is equal to or smaller than the predetermined value Sth is determined (Step S54), and whether or not the relative speed V of the controller 320R with respect to the HMD 110 is larger than the predetermined value Vth is determined (Step S55). Further, in response to a determination that none of the determination condition of Step S54 and the determination condition of Step S55 is satisfied, the right hand object 400R does not exert a predetermined effect on the operation portion 620. In this manner, through use of two different determination conditions, it is possible to more reliably determine whether or not the right hand object 400R has touched the operation portion 620 unintentionally. In particular, when the right hand object 400R has touched the operation portion 620 under a state in which the absolute speed S of the HMD 110 is larger than the predetermined value Vth and the relative speed v of the controller 320R with respect to the HMD 110 is larger than the predetermined value Vth, the right hand object 400R is determined to have touched the operation portion 620 unintentionally, and an effect of collision between the right hand object 400R and the operation portion 620 is not caused. Therefore, when the right hand object 400R has touched the operation portion 620 unintentionally, a situation in which the operation portion 620 is pressed by the right hand object 400R unintentionally can be avoided. In this manner, further improvement of the virtual experience of the user is possible.

The above description of embodiments is not to be read as a restrictive interpretation of the technical scope of this disclosure. The embodiments are merely given as an example, and is to be understood by a person skilled in the art that various modifications can be made to the embodiments within the scope of this disclosure set forth in the appended claims. Thus, the technical scope of this disclosure is to be defined based on the scope of this disclosure set forth in the appended claims and an equivalent scope thereof.

In the above described embodiments, the movement of the hand object is controlled based on the movement of the external controller 320 representing the movement of the hand of the user U, but the movement of the hand object in the virtual space may be controlled based on the movement amount of the hand of the user U. For example, instead of using the external controller, a glove-type device or a ring-type device to be worn on the hand or fingers of the user may be used. With this, the position sensor 130 can detect the position and the movement amount of the hand of the user U, and can detect the movement and the state of the hand and fingers of the user U. Further, the position sensor 130 may be a camera configured to take an image of the hand (including the fingers) of the user U. In this case, by taking an image of the hand of the user with use of a camera, the position and the movement amount of the hand of the user U can be detected, and the movement and the state of the hand and fingers of the user U can be detected based on data of the image in which the hand of the user is displayed, without wearing any kind of device directly on the hand or fingers of the user.

Further, in the above described embodiments, there is set a collision effect for defining the effect to be exerted on the wall object by the hand object based on the position and/or movement of the hand, which is a part of the body of the user U other than the head, but the embodiments are not limited thereto. For example, there may be set a collision effect for defining, based on a position and/or movement of a foot of the user U being a part of the body of the user U other than the head, an effect to be exerted on a target object by a foot object (example of operation object), which is synchronized with the movement of the foot of the user U. As described above, in the embodiments, there may be set a collision effect for identifying a relative relationship (distance and relative speed) between the HMD 110 and a part of the body of the user U, and defining the effect to be exerted on a target object by the operation object, which is synchronized with the part of the body of the user U, based on the identified relative relationship.

Further, in the above described embodiments, the wall object 500 is described as an example of a target object that the hand object exerts a predetermined effect on, but the attribute of a target object is not particularly limited. Further, an appropriate condition may be set as a condition for moving the virtual camera 300 other than a condition on collision between the hand object 400 and the wall object 500. For example, when a predetermined finger of the hand object 400 is directed to the wall object 500 for a predetermined period of time, the virtual camera 300 may be moved as well as the counter part 510 of the wall object 500. In this case, as in FIG. 2, through setting of three axes for the hand of the user U as well and definition of the roll axis as a finger pointing direction, providing the user U with an intuitive object operation and a moving experience in the VR space is possible.

In Non-Patent Document 1, there is no disclosure of setting a predetermined effect that is exerted on a predetermined object in the VR space in accordance with movement of the user in the real space. In particular, in Non-Patent Document 1, there is no disclosure of changing an effect (hereinafter referred to as “collision effect”) for defining an effect that is exerted on a virtual object (target object) by a hand object due to collision between the hand object and the virtual object in accordance with movement of the hand of the user. Therefore, there is room for improvement of experience in a VR space, an augmented reality (AR) space, and a mixed reality (MR) space of the user by improving the effect that is exerted on the virtual object in accordance with movement of the user.

(1) An information processing method to be executed in a system including a head-mounted device and a position sensor configured to detect a position of the head-mounted device and a position of a part of a body other than a head of a user. The information processing method includes generating virtual space data for defining a virtual space that includes a virtual camera, an operation object, and a target object. The method further includes updating a visual field of the virtual camera in accordance with movement of the head-mounted device. The method further includes generating visual-field image data based on the visual field of the virtual camera and the virtual space data. The method further includes displaying a visual-field image on the head-mounted device based on the visual-field image data. The method further includes moving the operation object in accordance with movement of the part of the body of the user. The method further includes identifying a relative relationship between the head-mounted device and the part of the body of the user. The method further includes setting a collision effect for defining an effect that is exerted by the operation object on the target object depending on the identified relative relationship.

According to the above-mentioned method, the collision effect is set depending on the relative relationship between the head-mounted device and the part (excluding the head of the user) of the body of the user, and thus further improvement of the experience (hereinafter referred to as “virtual experience”) of the user for the virtual object (target object) is possible.

(2) An information processing method according to Item (1), in which the setting of the collision effect includes setting a size of a collision area of the operation object depending on the identified relative relationship. The setting of the collision effect further includes exerting an effect on the target object depending on a positional relationship between the collision area of the operation object and the target object.

According to the above-mentioned method, the size of the collision area of the operation object is set depending on the relative relationship between the head-mounted device and the part (excluding the head of the user) of the body of the user, and in addition, an effect is exerted on the target object depending on the positional relationship between the collision area of the operation object and the target object. In this manner, further improvement of the virtual experience is possible.

(3) An information processing method according to Item (1) or (2), in which the identifying of the relative relationship includes a step of identifying a relative positional relationship between the head-mounted device and the part of the body of the user. The setting of the collision effect includes setting the collision effect depending on the identified relative positional relationship.

According to the above-mentioned method, the collision effect is set depending on the relative relationship between the head-mounted device and the part (excluding the head of the user) of the body of the user, and thus further improvement of the virtual experience is possible.

(4) An information processing method according to Item (3),

in which the identifying of the relative relationship includes a step of identifying a distance between the head-mounted device and the part of the body of the user. The setting of the collision effect includes setting the collision effect depending on the identified distance.

According to the above-mentioned method, the collision effect is set depending on the distance between the head-mounted device and the part (excluding the head of the user) of the body of the user, and thus further improvement of the virtual experience is possible.

(5) An information processing method according to Item (1) or (2),

in which the identifying of the relative relationship includes a step of identifying a relative speed of the part of the body of the user with respect to the head-mounted device. The setting of the collision effect includes setting the collision effect depending on the identified relative speed.

According to the above-mentioned method, the collision effect is set depending on the relative speed of the part (excluding the head of the user) of the body of the user with respect to the head-mounted device, and thus further improvement of the virtual experience is possible.

(6) An information processing method according to Item (4),

in which the identifying of the relative relationship includes a step of identifying a relative speed of the part of the body of the user with respect to the head-mounted device. The setting of the collision effect includes setting the collision effect depending on the identified distance and the identified relative speed.

According to the above-mentioned method, the collision effect is set depending on the distance between the head-mounted device and the part (excluding the head of the user) of the body of the user and the relative speed of the part of the body of the user with respect to the head-mounted device, and thus further improvement of the virtual experience is possible.

(7) An information processing method according to Item (1) or (2),

in which the identifying of the relative relationship further includes a step of identifying a relative acceleration of the part of the body of the user with respect to the head-mounted device. The setting of the collision effect includes setting the collision effect depending on the identified relative acceleration.

According to the above-mentioned method, the collision effect is set depending on the relative acceleration of the part (excluding the head of the user) of the body of the user with respect to the head-mounted device, and thus further improvement of the virtual experience is possible.

(8) An information processing method according to Item (4),

in which the identifying of the relative relationship further includes a step of identifying a relative acceleration of the part of the body of the user with respect to the head-mounted device. The setting of the collision condition includes setting the collision effect depending on the identified distance and the identified relative acceleration.

According to the above-mentioned method, the collision effect is set depending on the distance between the head-mounted device and the part (excluding the head of the user) of the body of the user and the relative acceleration of the part of the body of the user with respect to the head-mounted device, and thus further improvement of the virtual experience is possible.

(9) A system for executing the information processing method of any one of Items (1) to (8).

Providing a system capable of further improving the virtual experience is possible.

In Non-Patent Document 1, there is no disclosure of setting a predetermined effect that is exerted on a predetermined object in the VR space in accordance with movement of the user in the real space. In particular, in Non-Patent Document 1, there is no disclosure of changing an effect (hereinafter referred to as “collision effect”) for defining an effect that is exerted on a virtual object (target object) by a hand object due to collision between the hand object and the virtual object in accordance with movement of the hand of the user. Therefore, there is room for improvement of experience in the VR space, the augmented reality (AR) space, and the mixed reality (MR) space of the user by improving the effect that is exerted on the virtual object in accordance with movement of the user.

(10) An information processing method to be executed in a system including a head-mounted device and a position sensor configured to detect a position of the head-mounted device and a position of a part of a body other than a head of a user. The information processing method includes generating virtual space data for defining a virtual space that includes a virtual camera, an operation object, and a target object. The method further includes updating a visual field of the virtual camera in accordance with movement of the head-mounted device. The method further includes generating visual-field image data based on the visual field of the virtual camera and the virtual space data. The method further includes displaying a visual-field image on the head-mounted device based on the visual-field image data. The method further includes moving the operation object in accordance with movement of the part of the body of the user. The method further includes setting a collision effect for defining an effect that is exerted by the operation object on the target object depending on an absolute speed of the head-mounted device. Setting the collision effect includes setting the collision effect as a first collision effect when the absolute speed of the head-mounted device is equal to or smaller than a predetermined value. Setting the collision effect further includes setting the collision effect as a second collision effect different from the first collision effect when the absolute speed of the head-mounted device is larger than the predetermined value.

According to the above-mentioned method, the collision effect is set depending on the absolute speed of the head-mounted device. In particular, when the absolute speed of the head-mounted device is equal to or smaller than the predetermined value, the collision effect is set as the first collision effect, whereas when the absolute speed of the head-mounted device is larger than the predetermined value, the collision effect is set as the second collision effect. In this manner, further improvement of the experience (hereinafter referred to as “virtual experience”) of the user for the virtual object (target object) is possible.

(11) An information processing method according to Item 10, wherein setting the collision effect as the first collision effect includes setting, when the absolute speed of the head-mounted device is equal to or smaller than the predetermined value, a size of a collision area of the operation object to a first size. Setting the collision effect as the first collision effect includes exerting an effect on the target object depending on a positional relationship between the collision area of the operation object and the target object. Setting the collision effect as the second collision effect includes setting, when the absolute speed of the head-mounted device is larger than the predetermined value, the size of the collision area of the operation object to a second size different from the first size. Setting the collision effect as the second collision includes exerting an effect on the target object depending on the positional relationship between the collision area of the operation object and the target object.

According to the above-mentioned method, the size of the collision area of the operation object is set depending on the absolute speed of the head-mounted device. In particular, when the absolute speed of the head-mounted device is equal to or smaller than the predetermined value, the size of the collision area of the operation object is set to the first size. On the contrary, when the absolute speed of the head-mounted device is larger than the predetermined value, the size of the collision area of the operation object is set to the second size. Further, an effect is exerted on the target object depending on the positional relationship between the collision area of the operation object and the target object. In this manner, further improvement of the virtual experience is possible.

(12) An information processing method according to Item (10) or (11), further including identifying a relative speed of the part of the body of the user with respect to the head-mounted device. The setting of the collision effect includes setting the collision effect depending on the identified absolute speed of the head-mounted device and the identified relative speed.

According to the above-mentioned method, the collision effect is set depending on the absolute speed of the head-mounted device and the relative speed of the part (excluding the head of the user) of the body of the user with respect to the head-mounted device, and thus further improvement of the virtual experience is possible.

(13) An information processing method according to Item (10) or (11), further including identifying a relative acceleration of the part of the body of the user with respect to the head-mounted device. The setting of the collision effect includes setting the collision effect depending on the identified absolute speed of the head-mounted device and the identified relative acceleration.

According to the above-mentioned method, the collision effect is set depending on the absolute speed of the head-mounted device and the relative acceleration of the part (excluding the head of the user) of the body of the user with respect to the head-mounted device, and thus it is possible to further improve the virtual experience.

(14) A system for executing the information processing method of any one of Items (10) to (13).

Providing a system capable of further improving the virtual experience is possible.

In Non-Patent Document 1, the visual-field image presented on the HMD changes in accordance with movement of the head-mounted device in the real space. In this case, the user needs to move in the real space or perform input for designating a movement destination on a device, for example, a controller, in order for the user to reach a desired object in the VR space.

(20)

An information processing method to be executed by a computer configured to control a system including a head-mounted device and a position sensor configured to detect a position of the head-mounted device and a position of a part of a body other than a head of a user. The information processing method includes identifying virtual space data for defining a virtual space that includes a virtual camera, an operation object, and a target object. The method further includes moving the virtual camera in accordance with movement of the head-mounted device. The method further includes moving the operation object in accordance with movement of the part of the body. The method further includes moving the virtual camera without association with movement of the head-mounted device when the operation object and the target object satisfy a predetermined condition. The method further includes defining a visual field of the virtual camera based on movement of the virtual camera and generating visual-field image data based on the visual field and the virtual space data. The method further includes displaying a visual-field image on the head-mounted device based on the visual-field image data.

According to the information processing method of this item, when the operation object and the target object, which move in accordance with movement of the part of the body of the user, satisfy the predetermined condition, automatically moving the virtual camera is possible. With this, the user can recognize movement in the VR space that conforms to the intention of the user, and the virtual experience can be improved.

(Item 21)

A method according to Item 20, in which the moving of the virtual camera includes moving the operation object in accordance with movement of the virtual camera so that a relative positional relationship between the head-mounted device and the part of the body is maintained.

According to the information processing method of this item, the user can continue virtual experience using the operation object without feeling strange also after movement. With this, the virtual experience can be improved.

(Item 22)

A method according to Item 20 or 21, in which the predetermined condition includes touch between the operation object and the target object.

According to the information processing method of this item, the user can move in the VR space in accordance with the intention of the user.

(Item 23)

A method according to Item 22,

in which the moving of the virtual camera includes a step of processing a counter part of the target object, which is opposed to the virtual camera, based on the touch so that the counter part becomes away from the virtual camera. The method further includes moving the virtual camera so that the virtual camera approaches the counter part and the operation object does not touch the target object when the operation object is moved in accordance with movement of the virtual camera so as to keep a relative positional relationship between the head-mounted device and the part of the body.

According to the information processing method of this item, preventing occurrence of movement in the VR space that is not intended by the user due to the fact that the operation object has touched the target object after movement is possible.

(Item 24)

A method according to Item 22 or 23, in which the moving of the virtual camera includes moving the virtual camera in a direction of extension of a visual axis of the virtual camera at a time when the operation object and the target object have touched each other.

According to the information processing method of this item, the virtual camera is moved in a front direction of the user in the VR space, and thus preventing visually induced motion sickness (so-called VR sickness), which may be caused at the time of movement of the virtual camera is possible.

(Item 25)

A method according to Item 24, further including reducing a distance for which the virtual camera is moved as a position at which the operation object and the target object have touched each other becomes more away from the visual axis of the virtual camera.

According to the information processing method of this item, preventing occurrence of movement in the VR space that is not intended by the user due to the fact that the operation object has touched the target object after movement is possible.

(Item 26)

A method according to anyone of Items 22 to 25, further including avoiding moving the virtual camera when the position at which the operation object and the target object have touched each other is outside the visual field of the virtual camera.

According to the information processing method of this item, preventing occurrence of movement in the VR space that is not intended by the user is possible.

(Item 27)

A system for executing the method of any one of Items 20 to 26.

In the VR game disclosed in Non-Patent Document 1, an object may operate erroneously due to the hand object touching the object unintentionally during an operation of the hand object.

(30) An information processing method to be executed by a computer in a system including a head-mounted device and a position sensor configured to detect a position of the head-mounted device and a position of a part of a body other than a head of a user. The information processing method includes generating virtual space data for defining a virtual space that includes a virtual camera, an operation object, and a target object. The method further includes identifying a visual field of the virtual camera based on a position and an inclination of the head-mounted device. The method further includes displaying a visual-field image on the head-mounted device based on the visual field of the virtual camera and the virtual space data. The method further includes identifying a position of the operation object based on the position of the part of the body of the user. The method further includes avoiding causing the operation object to exert a predetermined effect on the target object when a predetermined condition for determining whether or not a collision area of the operation object has touched a collision area of the target object intentionally is not satisfied.

According to the above-mentioned method, when the predetermined condition for determining whether or not the collision area of the operation object has touched the collision area of the target object intentionally is not satisfied, the operation object does not exert a predetermined effect on the target object. In this manner, when the operation object is determined to have been touched the target object unintentionally, an effect of collision between the operation object and the target object does not occur. For example, a situation is avoided in which, when the hand object (example of operation object) has touched the button object (example of target object) unintentionally, the button object is pressed by the hand object unintentionally. Therefore, providing the information processing method capable of further improving the virtual experience of the user is possible.

(31) An information processing method according to Item (30), further including identifying an absolute speed of the head-mounted device, in which the predetermined condition specifies that the absolute speed of the head-mounted device is equal to or smaller than a predetermined value.

According to the above-mentioned method, when the absolute speed of the head-mounted device (HMD) is not equal to or smaller than the predetermined value (that is, absolute speed of HMD is larger than predetermined value), the operation object does not exert a predetermined effect on the target object. In this manner, when the operation object has touched the target object with the absolute speed of the HMD being larger than the predetermined value, the operation object is determined to have touched the target object unintentionally, and an effect of collision between the operation object and the target object does not occur.

(32) An information processing method according to Item (30) or (31), in which the predetermined condition includes a first condition and a second condition. The first condition is a condition on the head-mounted device. The second condition is a condition different from the first condition. The information processing method further includes avoiding causing the operation object to exert the predetermined effect on the target object when the first condition and the second condition are not satisfied.

According to the above-mentioned method, when the first condition and the second condition for determining whether or not the collision area of the operation object has touched the collision area of the target object intentionally are not satisfied, the operation object does not exert a predetermined effect on the target object. In this manner, reliably determining whether or not the operation object has touched the target object unintentionally by using two determination conditions different from each other is possible.

(33) An information processing method according to Item (32), further including identifying an absolute speed of the head-mounted device. The first condition specifies that the absolute speed of the head-mounted device is equal to or smaller than a predetermined value. The second condition specifies that the operation object is in the visual field of the virtual camera.

According to the above-mentioned method, when the absolute speed of the head-mounted device (HMD) is not equal to or smaller than the predetermined value (that is, absolute speed of HMD is larger than predetermined value) and that the operation object is outside the visual field of the virtual camera, the operation object does not exert a predetermined effect on the target object. In this manner, when the operation object has touched the target object with the absolute speed of the HMD being larger than the predetermined value and with the operation object being outside the visual field of the virtual camera, the operation object is determined to have touched the target object unintentionally, and an effect of collision between the operation object and the target object does not occur.

(34) An information processing method according to Item (32), further including identifying an absolute speed of the head-mounted device. The first condition specifies that the absolute speed of the head-mounted device is equal to or smaller than a predetermined value. The second condition specifies that at least one of the operation object and the target object is in the visual field of the virtual camera.

According to the above-mentioned method, when the absolute speed of the head-mounted device (HMD) is not equal to or smaller than the predetermined value (that is, absolute speed of HMD is larger than predetermined value) and that both of the operation object and the target object are outside the visual field of the virtual camera, the operation object does not exert a predetermined effect on the target object. In this manner, when the operation object has touched the target object with the absolute speed of the HMD being larger than the predetermined value and with both of the operation object and the target object being outside the visual field of the virtual camera, the operation object is determined to have touched the target object unintentionally, and an effect of collision between the operation object and the target object does not occur.

(35) An information processing method according to Item (32), further including identifying an absolute speed of the head-mounted device. The method further includes identifying a relative speed of the part of the body of the user with respect to the head-mounted device. The first condition specifies that the absolute speed of the head-mounted device is equal to or smaller than a predetermined value. The second condition specifies that the relative speed is larger than a predetermined value.

According to the above-mentioned method, the operation object does not exert a predetermined effect on the target object when the absolute speed of the head-mounted device (HMD) is not equal to or smaller than the predetermined value (that is, absolute speed of HMD is larger than predetermined value) and that the relative speed of the part of the body of the user with respect to the HMD is not larger than the predetermined value (that is, relative speed of part of body of user with respect to HMD is equal to or smaller than predetermined value). In this manner, when the operation object has touched the target object with the absolute speed of the HMD being larger than the predetermined value and with the relative speed of the part of the body of the user being equal to or smaller than the predetermined value, the operation object is determined to have touched the target object unintentionally, and an effect of collision between the operation object and the target object does not occur.

(36) A system for executing the information processing method of any one of Items (30) to (35).

According to the above-mentioned system, further improvement of the virtual experience of the user is possible.

1-9. (canceled)

10. A method comprising:
defining a virtual space that includes an operation object, and a target object;
generating visual-field image based on the virtual space;
displaying a visual-field image on a head-mounted display (HMD);
detecting a movement of the HMD;
updating the visual field image in response to a detected movement of the HMD;
detecting a position of a part of a body, other than a head, of a user of the HMD;
moving the operation object in response to a detected movement of the part of the body of the user;
identifying a relative relationship between the HMD and the part of the body of the user;
setting a collision effect between the operation object and the target object based on the identified relative relationship; and
exerting the collision effect by the operation object on the target object.

11. The method according to claim 10, wherein the setting of the collision effect comprises:
setting a size of a collision area of the operation object based on the identified relative relationship;
identifying a positional relationship between the collision area and the target object; and
exerting the collision effect on the target object depending on the positional relationship between the collision area and the target object.

12. The method according to claim 10,
wherein the identifying of the relative relationship comprises identifying a relative positional relationship between the HMD and the part of the body of the user, and
wherein the setting of the collision effect comprises setting the collision effect depending on the identified relative positional relationship.

13. The method according to claim 12,
wherein the identifying of the relative relationship comprises identifying a distance between the HMD and the part of the body of the user, and
wherein the setting of the collision effect comprises setting the collision effect depending on the identified distance.

14. The method according to claim 10,
wherein the identifying of the relative relationship comprises identifying a relative speed of the part of the body of the user with respect to the HMD, and
wherein the setting of the collision effect comprises setting the collision effect depending on the identified relative speed.

15. The method according to claim 13,
wherein the identifying of the relative relationship comprises identifying a relative speed of the part of the body of the user with respect to the HMD, and
wherein the setting the collision effect comprises setting the collision effect depending on the identified distance and the identified relative speed.

16. The method according to claim 10,
wherein the identifying of the relative relationship comprises identifying a relative acceleration of the part of the body of the user with respect to the HMD, and
wherein the setting of the collision effect comprises setting the collision effect depending on the identified relative acceleration.

17. The method according to claim 13,
wherein the identifying of the relative relationship comprises identifying a relative acceleration of the part of the body of the user with respect to the HMD, and
wherein the setting of the collision effect comprises setting the collision effect depending on the identified distance and the identified relative acceleration.

18. The method according to claim 11, further comprising:
changing a state of the target object in response to exerting the collision effect on the target object; and
displaying the changed state of the target object on the HMD.

19. The method according to claim 18,
wherein the virtual space includes a virtual camera for defining a visual-field of the virtual space, the visual-field image is generated based on the virtual space data and the visual-field;
the method further comprising moving the virtual camera in response to the changed state of the target object.

20. The method according to claim 11, wherein the setting of the size of the collision area of the operation object is based on a relative speed between the part of the body of the user with respect to the HMD.

21. The method according to claim 11, wherein the setting of the size of the collision area of the operation object is based on an absolute speed of the HMD.

22. The method according to claim 11, wherein the setting of the size of the collision area of the operation object comprises setting the size of the collision area in a step-wise manner based on an absolute speed of the HMD.

23. The method according to claim 10, wherein the setting of the collision effect comprises:
setting a size of a collision area of the operation object based on the identified relative relationship and a detected actuation of an external controller; and
exerting the collision effect on the target object depending on a positional relationship between the collision area of the operation object and the target object.

24. The method according to claim 10, wherein the setting of the collision effect comprises:
setting a size of a collision area of the operation object based on the identified relative relationship and whether the operation object is present in the visual field; and
exerting the collision effect on the target object depending on a positional relationship between the collision area of the operation object and the target object.

25. A system comprising:
a head-mounted display (HMD);
a position sensor configured to detect a position of the HMD, wherein the position sensor is further configured to detect a position of a part of a body, other than a head, of a user; and
a controller connected to the HMD and the position sensor, wherein the controller is configured to:
define a virtual space that includes an operation object, and a target object;
generate visual-field image based on the virtual space;
display the visual field image on the HMD;
detect a movement of the HMD;
update the visual field image in response to a detected movement of the HMD;
move the operation object in response to a detected movement of the part of the body of the user;
identify a relative relationship between the HMD and the part of the body of the user; and
set a collision effect between the operation object and the target object based on the identified relative relationship;
exert the collision effect by the operation object on the target object.

26. The system of claim 25, further comprising an external controller, wherein the external controller is configured to attach to the part of the body of the user.

27. The system of claim 25, wherein the controller is further configured to:
set a size of a collision area of the operation object based on the identified relative relationship; and
exert the collision effect on the target object depending on a positional relationship between the collision area of the operation object and the target object.

28. The system of claim 27, wherein the controller is further configured to change a state of the target object in the visual field in response to the collision effect exerted on the target object.

29. A method comprising:
defining a virtual space that includes an operation object, and a target object;
generating visual-field image based on the virtual space;
displaying a visual-field image on the HMD;
detecting a movement of the HMD;
updating the visual field image in response to a detected movement of the HMD;
moving the operation object in accordance with a detected movement of the part of the body of the user;
identifying a relative relationship between the HMD and the part of a body of a user of the HMD;
setting a collision area of the operation object based on the identified relative relationship;
setting a collision effect between the operation object and the target object based on the identified relative relationship;
exerting the collision effect on the target object in response to the collision area of the operation object contacting the target object;
changing a state of the target object in response to exerting the collision effect; and
displaying the target object having the changed state on the HMD.
